(19) United States
(12) Patent Application Publication
(10) Pub. No.: US 2026/0233096 A1
(43) Pub. Date: Aug. 13, 2026

(54) VIRTUAL ITEM EFFECT DISPLAY

(71) Applicant: Tencent Technology (Shenzhen) Company Limited, Shenzhen (CN)

(72) Inventor: Yizhou LI, Shenzhen (CN)

(73) Assignee: Tencent Technology (Shenzhen) Company Limited, Shenzhen (CN)

(21) Appl. No.: 19/638,106

(22) Filed: Apr. 2, 2026

Related U.S. Application Data
(63) Continuation of application No. PCT/CN2025/083979, filed on Mar. 21, 2025.

(30) Foreign Application Priority Data
Mar. 27, 2024 (CN) 202410373547.X

(51) Int. Cl. A63F 13/533; A63F 13/537; A63F 13/54; A63F 13/822; A63F 13/837

(52) U.S. Cl. CPC A63F 13/533; A63F 13/537; A63F 13/54; A63F 13/822; A63F 13/837

(57) ABSTRACT

In a method for displaying an item effect, a user interface and a virtual scene of the virtual environment observed from a perspective of a controlled virtual character are output for display. The controlled virtual character carries an explosive virtual item. An item use operation performed on an item control element in the user interface corresponding to the explosive virtual item is received. Based on the item use operation, the controlled virtual character using the explosive virtual item is output for display. The explosive virtual item is a virtual item that generates an effect within an effective range. Whether the explosive virtual item acts on a target virtual character is determined. When the explosive virtual item acts on the target virtual character, voiceprint indication information that indicates a source position of a take-hit sound caused by the explosive virtual item acting on a target virtual character is output for display.

### RELATED APPLICATIONS

The present application is a continuation of International Application No. PCT/CN2025/083979, filed on March 21, 2025, which claims priority to Chinese Patent Application No. 202410373547.X, filed on March 27, 2024. The entire disclosures of the prior applications are hereby incorporated by reference.

### FIELD OF THE TECHNOLOGY

This disclosure relates to the field of applications supporting virtual environments, including methods and apparatuses for displaying an item effect, devices, and storage media.

### BACKGROUND OF THE DISCLOSURE

In a first-person shooting (FPS) game, a user account can control a main control virtual character to use a throwing virtual item (for example, a virtual grenade), to attack a virtual character of an enemy camp.

In related technology, after a user account controls a main control virtual character to hit an enemy virtual character, an outline of the enemy virtual character is highlighted in an interface of the main control virtual character, to indicate a position of the enemy virtual character.

The main control virtual character cannot observe a blocked enemy virtual character through an obstacle (for example, a wall). Therefore, when the obstacle between the main control virtual character and the enemy virtual character blocks a line of sight of the main control virtual character, displaying the highlighted outline of the enemy virtual character through the obstacle violates natural laws.

### SUMMARY

Aspects of this disclosure provide methods and apparatuses for displaying an item effect, devices, and storage media including a non-transitory computer-readable storage medium, for example, to display a take hit effect of an explosive virtual item. Examples of technical solutions of this disclosure may be implemented as follows:

An aspect of this disclosure provides a method for displaying an item effect in a virtual environment. In the method, a user interface and a virtual scene of the virtual environment observed from a perspective of a controlled virtual character are output for display. The controlled virtual character carries an explosive virtual item. An item use operation performed on an item control element in the user interface corresponding to the explosive virtual item is received. Based on the item use operation, the controlled virtual character using the explosive virtual item is output for display. The explosive virtual item is a virtual item that generates an effect within an effective range. Whether the explosive virtual item acts on a target virtual character is determined. When the explosive virtual item acts on the target virtual character, voiceprint indication information that indicates a source position of a take-hit sound caused by the explosive virtual item acting on the target virtual character is output for display.

An aspect of this disclosure provides an apparatus for displaying an item effect in a virtual environment. The apparatus includes processing circuitry configured to output for display a user interface and a virtual scene of the virtual environment observed from a perspective of a controlled virtual character. The controlled virtual character carries an explosive virtual item. The processing circuitry is configured to receive an item use operation performed on an item control element in the user interface corresponding to the explosive virtual item. The processing circuitry is configured to output for display, based on the item use operation, the controlled virtual character using the explosive virtual item. The explosive virtual item is a virtual item that generates an effect within an effective range. The processing circuitry is configured to determine whether the explosive virtual item acts on a target virtual character. The processing circuitry is configured to output for display, when the explosive virtual item acts on the target virtual character, voiceprint indication information that indicates a source position of a take-hit sound caused by the explosive virtual item acting on the target virtual character.

An aspect of this disclosure provides a method for displaying an item effect. The method is performed by a computer device and includes: displaying a user interface, a virtual environment picture displayed in the user interface being a picture of a virtual environment observed from a perspective corresponding to a main control virtual character, and the main control virtual character carrying an explosive virtual item; displaying, in response to an item use operation, use of the explosive virtual item by the main control virtual character, the explosive virtual item being a virtual item producing an effect in an effective range; and displaying voiceprint indication information corresponding to a target virtual character when the explosive virtual item acts on the target virtual character, the voiceprint indication information being configured for indicating a source position of a take hit sound caused by the action of the explosive virtual item.

An aspect of this disclosure provides an apparatus for displaying an item effect and includes: a display module, configured to display a user interface, a virtual environment picture displayed in the user interface being a picture of a virtual environment observed from a perspective corresponding to a main control virtual character, and the main control virtual character carrying an explosive virtual item; the display module being configured to display, in response to an item use operation, use of the explosive virtual item by the main control virtual character, the explosive virtual item being a virtual item producing an effect in an effective range; and the display module being configured to display voiceprint indication information corresponding to a target virtual character when the explosive virtual item acts on the target virtual character, the voiceprint indication information being configured for indicating a source position of a take hit sound caused by the action of the explosive virtual item.

An aspect of this disclosure provides a computer device, the computer device including a processor and a memory, the memory having at least one program stored therein, the at least one program being loaded and executed by the processor to implement the method for displaying an item effect in the aspects of this disclosure.

An aspect of this disclosure provides a non-transitory computer-readable storage medium storing instructions which, when executed by a processor, cause the processor to implement the method for displaying an item effect in the aspects of this disclosure.

An aspect of this disclosure provides a computer program product or a computer program, the computer program product or the computer program including computer instructions, the computer instructions being stored in a computer-readable storage medium, a processor of a computer device reading the computer instructions from the computer-readable storage medium, and the processor executing the computer instructions, to cause the computer device to perform the method for displaying an item effect in the aspects of this disclosure.

Aspects of this disclosure include the following beneficial effects:

A new method for displaying an item effect is provided. A voiceprint indication function is set for an explosive virtual item. After a main control virtual character hits a target virtual character by using the explosive virtual item, voiceprint indication information of the target virtual character is exposed to the main control virtual character based on a take hit sound of the target virtual character, and the voiceprint indication information is configured for indicating a position of the target virtual character. Compared with a manner of highlighting a character outline of a hit target virtual character through an obstacle in a related technology, sound localization in reality can be simulated by using the voiceprint indication information, to indicate the position of the target virtual character to the main control virtual character, and the main control virtual character may further explore based on the voiceprint indication information, thereby improving man-machine interaction efficiency.

### BRIEF DESCRIPTION OF THE DRAWINGS

FIG. 1 is a schematic structural diagram of a terminal according to an aspect of this disclosure.

FIG. 2 is a structural block diagram of a computer system according to an aspect of this disclosure.

FIG. 3 is a schematic flowchart of a method for displaying an item effect according to an aspect of this disclosure.

FIG. 4 is a schematic diagram of a camera model according to an aspect of this disclosure.

FIG. 5 is a schematic diagram of an interface of a method for displaying an item effect according to an aspect of this disclosure.

FIG. 6 is a schematic flowchart of a method for displaying an item effect according to an aspect of this disclosure.

FIG. 7 is a schematic diagram of a take hit animation according to an aspect of this disclosure.

FIG. 8 is a schematic diagram of a relationship curve according to an aspect of this disclosure.

FIG. 9 is a schematic diagram of an activation method of an explosive virtual item according to an aspect of this disclosure.

FIG. 10 is a schematic flowchart of a method for displaying an item effect according to an aspect of this disclosure.

FIG. 11 is a schematic diagram of a key joint point according to an aspect of this disclosure.

FIG. 12 is a schematic flowchart of a method for displaying an item effect according to an aspect of this disclosure.

FIG. 13 is a schematic flowchart of a method for displaying an item effect according to an aspect of this disclosure.

FIG. 14 is a schematic diagram of a configuration interface of a method for displaying an item effect according to an aspect of this disclosure.

FIG. 15 is a schematic diagram of a configuration interface of a method for displaying an item effect according to an aspect of this disclosure.

FIG. 16 is a schematic diagram of a configuration interface of a method for displaying an item effect according to an aspect of this disclosure.

FIG. 17 is a schematic structural diagram of an apparatus for displaying an item effect according to an aspect of this disclosure.

FIG. 18 is a schematic structural diagram of a terminal according to an aspect of this disclosure.

### DETAILED DESCRIPTION

Examples of terms involved in the aspects of the disclosure are briefly introduced. The descriptions of the terms are provided as examples only and are not intended to limit the scope of the disclosure.

Virtual environment: A virtual environment may be displayed (or provided) by an application when run on a terminal. The virtual environment may be a simulated environment of a real world, or may be a semi-simulated semi-fictional environment, or may be an entirely fictional environment. The virtual environment may be any one of a two-dimensional virtual environment, a 2.5-dimensional virtual environment, or a three-dimensional virtual environment. This is not limited in the aspects of this disclosure.

Virtual character: A virtual character may be a movable object in a virtual environment. The movable object may be a virtual person, a virtual animal, a cartoon character, or the like, and may be, for example, a character displayed in a three-dimensional (3D) virtual environment. In some aspects, the virtual character is a three-dimensional model created based on an animation skeleton technology. Each virtual character has a respective shape and size in a three-dimensional virtual world, and occupies some space in the three-dimensional virtual world.

Virtual item: A virtual item may refer to an item used by a virtual character in a virtual environment, and include at least one of the following: a virtual attack item that can cause damage to another virtual character, like a grenade, a flash grenade, a smoke grenade, an incendiary grenade, a stun grenade, a missile, a rocket, a pistol, a rifle, a sniper, a dagger, a knife, a sword, or an ax, a supplement item like a bullet, a virtual accessory that is mounted on a specified virtual attack item and that can provide some attribute bonuses to the virtual attack item, like a quick response clip, an aiming mirror, or a muffler, and a defense item like a shield, armor, or an armored vehicle.

Explosive virtual item: An explosive virtual item may refer to a virtual item that acts on a virtual character in an effective range through explosion after being used. For example, the explosive virtual item may include at least one of the following: a grenade, a flash grenade, a smoke grenade, an incendiary grenade, a stun grenade, a missile, or a rocket. The explosive virtual item may be a throwing virtual item (namely, a virtual item used by throwing), a launching virtual item (namely, a virtual item used by launching, like a missile), or a virtual item used in another manner. The explosive virtual item is an item having an effect in a range, and after taking effect, produces an effect on a virtual character in an effective range. The effect may include at least one of the following: debuff effects (for example, reducing a hit point value, reducing a movement speed, paralyzing an action, blocking a line of sight, or reducing a defense value), or gain effects (for example, adding a protection cover, increasing a defense value, increasing a movement speed, enhancing a signal, or interfering with an enemy attack).

Throwing virtual item: A throwing virtual item may be a virtual item used by a virtual character in a virtual environment by throwing. For example, division is performed based on functions. Throwing virtual items include a damage-type throwing virtual item and a non-damage-type throwing virtual item. The damage-type throwing virtual item may cause damage to a virtual character, and is, for example, a virtual grenade, a virtual incendiary grenade, a virtual viscosity bomb, or a virtual toxic smoke grenade. The non-damage-type throwing virtual item does not cause damage to a virtual character, but causes functional impact, and is, for example, a virtual smoke grenade, a virtual stun grenade, or a virtual flash grenade. In some aspects, a target function of a throwing virtual item may be triggered when a duration for which the virtual item is thrown reaches a preset duration, or the target function may be triggered when the throwing virtual item is thrown and is collided.

User interface (UI) control: A UI control may be any visual control or element that can be seen in a user interface of an application, and is, for example, a picture, an input box, a text box, a button, a label, or another control. Some UI controls respond to an operation of a user.

First-person shooting (FPS) game: An FPS game may be a shooting game in which a user account can play from a first-person perspective. A virtual environment picture in the game is a picture of a virtual environment observed from a perspective of a virtual character controlled by the user account. In the game, virtual characters in at least two camps play in a single-round battle mode in the virtual environment. A virtual character evades attacks from other virtual characters and dangers (such as a poison gas area and a swamp) in the virtual environment to survive in the virtual environment. When a hit point value of the virtual character in the virtual environment is zero, the life of the virtual character in the virtual environment ends, and a final virtual character surviving in the virtual environment wins. In some aspects, arena modes of the battle (match) may include a single-player battle mode, a two-player team battle mode, or a multi-player team battle mode. The battle mode is not limited in the aspects of this disclosure.

The method for displaying an item effect provided in this disclosure may be applied to an application supporting a virtual environment. The application supporting a virtual environment is an application in which a user account can control behavior of a virtual character in the virtual environment. For example, the method for displaying an item effect provided in this disclosure may be applied to any one of: a virtual reality (VR) application, an augmented reality (AR) application, a social application, an interactive entertainment application, a meta-universe application, a three-dimensional map program, a VR game, an AR game, a shooting game (STG), a first-person shooting game (FPS), a third-person shooting game (TPS), a fight technology game (FTG), an action game (ACT), a multiplayer online battle arena (MOBA) game, a real-time strategy game (RTS), a massive/massively multiplayer online game (MMOG), an arcade game, a simulation game (SLG), a racing game, a role play game, an adventure game, a sandbox game, a battle royale (BR) game, and a car racing game. In some aspects, the application may be a standalone application, like a standalone 3D game program, or may be an online application.

For example, a game in a virtual environment is formed by maps of one or more game worlds. The virtual environment in the game can simulate scenarios in the real world. A user account may control a virtual character in the game to perform actions such as walking, running, jumping, shooting, engaging targets, and driving in the virtual environment, and may further control a virtual vehicle to travel in the virtual environment. The interactivity is high. In addition, a plurality of user accounts may form a team online to play an arena game.

In an aspect, a client of an application supporting a virtual environment may support at least one of a Windows operating system, an Apple operating system, an Android operating system, an IOS operating system, or a LINUX operating system, and clients of different operating systems may be interconnected.

In some aspects, the client is a program configured to a mobile terminal having a touchscreen. For example, the method for displaying an item effect provided in the aspects of this disclosure may be applied to an application supporting a shooting game, where a player may use an explosive virtual item by controlling a virtual character. For another example, the method for displaying an item effect provided in the aspects of this disclosure may be applied to an application supporting a role play game, where a player may also use an explosive virtual item by controlling a virtual character. In some aspects, the client is an application developed based on a three-dimensional engine. For example, the three-dimensional engine is a Unity engine.

The method for displaying an item effect provided in this disclosure may be performed by a computer device. The computer device may be a terminal. Types of the terminal include a desktop computer, a portable laptop computer, a mobile phone, a tablet computer, an ebook reader, a moving picture experts group audio layer III (MP3) player, a moving picture experts group audio layer IV (MP4) player, and the like. A client supporting a virtual environment, for example, a client of an application supporting a three-dimensional virtual environment, is installed and runs in the terminal.

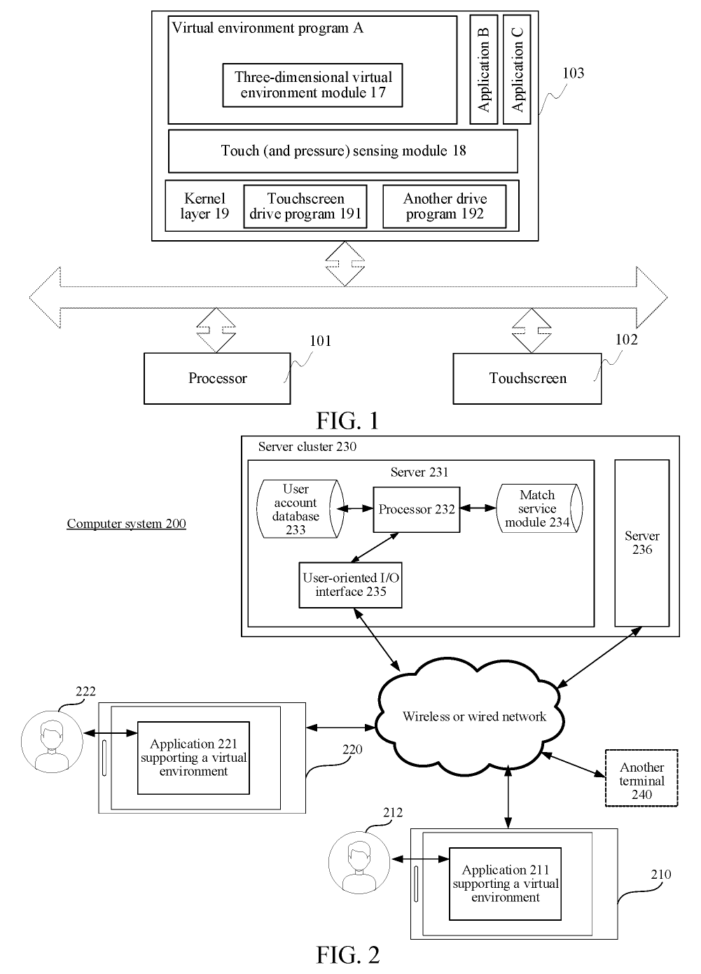

FIG. 1 is a schematic structural diagram of a terminal according to an aspect of this disclosure. The terminal includes a processor 101, a touchscreen 102, and a memory 103.

The processor 101 may be at least one of a single-core processor, a multi-core processor, an embedded chip, or a processor with an instruction execution capability. The touchscreen 102 includes a regular touchscreen or a pressure sensing touchscreen. The regular touchscreen can measure a pressing operation or sliding operation applied on the touchscreen 102; and the pressure sensing touchscreen can measure pressing strength applied on the touchscreen 102.

The memory 103 has at least one program of the processor 101 stored therein. For example, the memory 103 has a virtual environment program A, an application B, an application C, a touch (and pressure) sensing module 18, and a kernel layer 19 of an operating system stored therein. The virtual environment program A is an application developed based on a three-dimensional virtual environment module 17. In some aspects, the virtual environment program A includes, but is not limited to, at least one of a game program, a virtual reality program, a three-dimensional map program, and a three-dimensional demonstration program that are developed by the three-dimensional virtual environment module (which is also referred to as a virtual environment module) 17. For example, when the operating system of the terminal is an Android operating system, the virtual environment program A is developed by using Java programming language and C# language. For another example, when the operating system of the terminal is an IOS operating system, the virtual environment program A is developed by using Object-C programming language and C# language.

The three-dimensional virtual environment module 17 is a module that supports a plurality of operating system platforms. For example, the three-dimensional virtual environment module may be configured for program development in a plurality of fields such as game development, virtual reality (VR), and three-dimensional maps. An example type of the three-dimensional virtual environment module 17 is not limited in the aspect of this disclosure.

The touch (and pressure) sensing module 18 is a module configured to receive a touch event (and a pressure touch and control event) reported by a touchscreen drive program 191. In some aspects, the touch sensing module may not have a pressure sensing function, and does not receive a pressure touch event. The touch event includes: a type and coordinate values of the touch event. The type of the touch event includes, but is not limited to, a touch start event, a touch move event, and a touch drop event. The pressure touch event includes a pressure value and coordinate values of the pressure touch event. The coordinate values are configured for indicating a touch position of a pressure touch operation on a display screen.

For example, the kernel layer 19 includes the touchscreen drive program 191 and another drive program 192. The touchscreen drive program 191 is a module configured to detect the pressure touch event. When detecting the pressure touch event, the touchscreen drive program 191 transfers the pressure touch event to the touch (and pressure) sensing module 18.

The another drive program 192 may be a drive program related to the processor 101, a drive program related to the memory 103, a drive program related to a network component, a drive program related to a sound component, a drive program related to an acceleration measurement component, or the like.

It is noted that the foregoing is a general illustration of a structure of the terminal. In different aspects, the terminal may have more or fewer components. For example, the terminal may further include an acceleration sensor, a gyroscope sensor, a power supply, and the like.

FIG. 2 is a structural block diagram of a computer system according to an aspect of this disclosure. The computer system 200 includes a first terminal 210, a second terminal 220, and a server cluster 230.

An application 211 supporting a virtual environment is installed and run on the first terminal 210. The application 211 may be a client supporting a virtual environment. When the first terminal 210 runs the application 211, a user interface of the application 211 is displayed on a screen of the first terminal 210. The application 211 may be any one of an FPS game, a TPS game, an MOBA game, an arena game, an SLG game, a racing game, and a car racing game. In this aspect of this disclosure, an example in which the application 211 is the FPS game is used for description. The first terminal 210 is a terminal used by a first user 212. The first user 212 uses the first terminal 210 to control behavior, for example, use of an explosive virtual item, of a first virtual character in a virtual environment.

An application 221 supporting a virtual environment is installed and run on the second terminal 220. The application 221 may be a client supporting a virtual environment. When the second terminal 220 runs the application 221, a user interface of the application 221 is displayed on a screen of the second terminal 220. The application 221 may be any one of an FPS game, a TPS game, an MOBA game, an arena game, an SLG game, a racing game, and a car racing game. In some aspects, the application 221 and the application 211 are the same, or the same application in different operating systems, or different versions of the same application. The second terminal 220 is a terminal used by a second user 222. The second user 222 uses the second terminal 220 to control behavior, for example, use of an explosive virtual item, of a second virtual character in the virtual environment. At least one third virtual character further exists in the virtual environment, and the third virtual character is controlled by a third user of an application on a third terminal.

Device types of the first terminal 210 and the second terminal 220 include at least one of a smartphone, a tablet computer, an e-book reader, an MP3 player, an MP2 player, a portable laptop computer, or a desktop computer.

FIG. 2 shows only two terminals. However, there are a plurality of other terminals 240 in different aspects. In some aspects, there is at least one another terminal 240 which is a terminal corresponding to a developer. A developing and editing platform for the client supporting a virtual environment is installed on the another terminal 240. The developer may edit and update the client on the another terminal 240, and transmit an updated client installation package to the server cluster 230 via a wired or wireless network. The first terminal 210 and the second terminal 220 may download the client installation package from the server cluster 230 to update the client.

The first terminal 210, the second terminal 220, and the another terminal 240 are connected to the server cluster 230 via a wireless or wired network.

The server cluster 230 includes at least one of one server, a plurality of servers, a cloud computing platform, or a virtualization center. The server cluster 230 is configured to provide a backend service for a client supporting a virtual environment. In some aspects, the server cluster 230 takes on primary computing work, and the terminals take on secondary computing work. Alternatively, the server cluster 230 takes on the secondary computing work, and the terminals take on the primary computing work. Alternatively, collaborative computing is performed by using a distributed computing architecture between the server cluster 230 and the terminals.

In some aspects, the terminals and the servers are all computer devices.

In a schematic example, the server cluster 230 includes a server 231 and a server 236. The server 231 includes a processor 232, a user account database 233, a match service module 234, and a user-oriented input/output interface (I/O interface) 235. The processor 232 is configured to load instructions stored in the server 231 and process data in the user account database 233 and the match service module 234. The user account database 233 is configured to store data of user accounts used by the first terminal 210, the second terminal 220, and the another terminal 240, such as avatars of the user accounts, nicknames of the user accounts, virtual items possessed by the user accounts, and service areas where the user accounts are located. The match service module 234 is configured to provide a service for matches between virtual characters from different camps. The user-oriented I/O interface 235 is configured to establish communication with the first terminal 210 via a wireless or wired network to exchange data.

With reference to the foregoing descriptions about the virtual environment and descriptions about the implementation environment, the following describes the method for displaying an item effect according to the aspects of this disclosure.

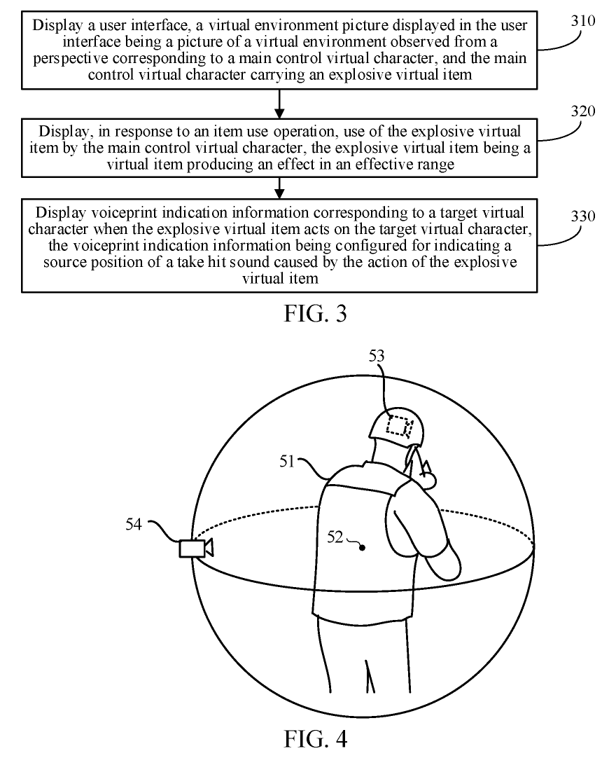

FIG. 3 is a schematic flowchart of a method for displaying an item effect according to an aspect of this disclosure. The method may be performed by a computer device. The computer device may be a terminal. For example, the method may be applied to the terminal shown in FIG. 1 or the client supporting a virtual environment in the terminal, or may be applied to the first terminal in the system shown in FIG. 2 or the client supporting a virtual environment in the first terminal. The method includes at least some of operation 310, operation 320, and operation 330 below.

Operation 310 : Display a user interface, a virtual environment picture displayed in the user interface being a picture of a virtual environment observed from a perspective corresponding to a main control virtual character, and the main control virtual character carrying an explosive virtual item. For example, a user interface and a virtual scene of the virtual environment observed from a perspective of a controlled virtual character are output for display. The controlled virtual character carries an explosive virtual item.

The user interface is an interface that is in a client and provides a match function for a main control virtual character. The main control virtual character may also be referred to as a "controlled virtual character." A client of a shooting game application is used as an example. The user interface may be a battle interface in the shooting game application. The virtual environment picture is displayed in the user interface, and the virtual environment picture is a picture of the virtual environment observed from the perspective of the main control virtual character. In some aspects, a target virtual character may further be displayed in the virtual environment picture of the user interface.

A UI control may further be displayed in the user interface. For example, the UI control may include at least one of the following: a shooting control, a throwing control, an equipment switching control, a movement control, a jumping control, a pop-up control, an orientation compass (for example, a "directional indicator"), or the like. The orientation compass is configured to indicate an orientation. The orientation compass may indicate a direction that the main control virtual character currently faces. When the orientation of the main control virtual character changes, the direction indicated by the orientation compass correspondingly changes.

The virtual environment may be a simulated environment of the real world, a semi-simulated and semi-fictional environment, or a fictional environment. In some aspects, a virtual environment displayed by a client in an FPS game is displayed through observation of a virtual environment from a first-person perspective corresponding to a main control virtual character controlled by a user account. In some aspects, a virtual environment displayed by a client in a TPS game is displayed through observation of a virtual environment from a third-person perspective corresponding to a main control virtual character controlled by a user account, and the perspective changes according to a control operation performed by the user account on the virtual character controlled by the user account.

For example, the virtual environment displayed by the client is obtained by capturing pictures of the virtual environment by using a camera model disposed in the virtual environment. The camera model is a three-dimensional model located around the virtual character in the virtual environment. When the first-person perspective is used, the camera model is located near a head of the virtual character or is located at the head of the virtual character. When the third-person perspective is used, the camera model may be located at the rear of the virtual character and bound to the virtual character, or the camera model is located at any position apart from the virtual character by a preset distance. The virtual character in the virtual environment may be observed from different angles by using the camera model. For example, the camera model is located at a left side of the virtual character and is apart from the virtual character by a preset distance. For another example, the camera model is located at a right side of the virtual character and is apart from the virtual character by a preset distance. For another example, the camera is located at the left front of the virtual character and is apart from the virtual character by a preset distance. For another example, the camera is located at the right rear of the virtual character and is apart from the virtual character by a preset distance.

In some environments, the camera model is not actually displayed in the virtual environment. In other words, the camera model is not displayed in the virtual environment displayed in the user interface.

An example in which the camera model is located at any position apart from the virtual character by a preset distance is used for description. In some aspects, one perspective corresponds to one camera model, or one perspective is bound to one camera model. The camera model may rotate with the virtual character as a rotation center. For example, the camera model is rotated with any point of the virtual character as the rotation center. During rotation, the camera model is not only rotated, but also displaced. During rotation, a distance between the camera model and the rotation center remains unchanged. In other words, the camera model is rotated on a surface of a sphere with the rotation center as a sphere center. Any point of the virtual character may be the head or the torso of the virtual character, or any point around the virtual character. This is not limited in the aspects of this disclosure. In some aspects, when the camera model observes the virtual environment, a center orientation of the perspective of the camera model is a direction of a point of a sphere surface where the camera model is located pointing to the sphere center.

In some aspects, the camera model may further observe the virtual character from different directions of the virtual character at a preset angle.

For example, FIG. 4 is a schematic diagram of a camera model according to an aspect of this disclosure. As shown in FIG. 4, a point is determined in a main control virtual character 51 as a rotation center 52, and the camera model may rotate around the rotation center 52. When the camera model rotates around the rotation center 52, a perspective direction of the camera model also changes with rotation of the camera model. In some aspects, a first perspective (a first-person perspective) of the main control virtual character 51 is bound to a first camera, and an initial position is configured for the first camera. For example, the initial position is a position of a head of the main control virtual character, for example, a position 53. For example, when receiving a perspective switching operation, a client switches the first perspective of the main control virtual character 51 to a second perspective (a third-person perspective). The second perspective is bound to a second camera. An initial position is also configured for the second camera. For example, the initial position is a position 54. Therefore, after the perspective switching operation is performed, a camera model observing a virtual environment is switched from the first camera to the second camera, and a position of the camera model observing the virtual environment is correspondingly switched from the position 53 to the position 54. When the camera model moves along with movement of the main control virtual character, or switches to different perspectives, a virtual environment picture displayed by the client also changes correspondingly.

For example, the computer device is a terminal, a first user account is logged into on the terminal, and the main control virtual character may be a virtual character controlled by the first user account. In some aspects, because the main control virtual character may use an explosive virtual item, the main control virtual character may also be referred to as an item user.

The target virtual character may be a virtual character controlled by another user account. For example, the target virtual character may be a virtual character controlled by a second user account, and the second user account may be a user account logged into on a second terminal. The target virtual character may alternatively be a virtual character automatically controlled by a system (a client or a server). For example, the target virtual character is a virtual character controlled by artificial intelligence (AI). In this case, the target virtual character may be referred to as a non-player character (NPC). In some aspects, because the target virtual character may be hit by an explosive virtual item, the target virtual character may also be referred to as a take hit character.

The virtual character in the aspects of this disclosure is a movable object in the virtual environment. The movable object may be a virtual person, a virtual animal, a cartoon character, or the like, and may be, for example, a character displayed in a three-dimensional (three-dimensional) virtual environment. In some aspects, the virtual environment may further include at least one third virtual character, and the third virtual character is a virtual character controlled by a third user account, or the third virtual character may be controlled by the system.

Camps to which the main control virtual character and the target virtual character belong may be different. For example, when the main control virtual character belongs to a first camps, and the target virtual character belongs to a second camps, the target virtual character may also be referred to as an enemy virtual character. A match is participated by virtual characters of at least two camps. During the match, virtual characters of different camps beat a virtual character of an enemy camp by attacking each other, to win the match. In some aspects, camps to which the main control virtual character and the target virtual character belong may alternatively be the same.

In the user interface, the main control virtual character may hold an explosive virtual item, or an equipment bar of the main control virtual character is equipped with an explosive virtual item, or a backpack of the main control virtual character carries an explosive virtual item. The first user account may control, by triggering a use control corresponding to the explosive virtual item, the main control virtual character to use the explosive virtual item.

The explosive virtual item is a virtual item owned by the main control virtual character. In some aspects, the main control virtual character has a virtual backpack, and the virtual backpack is configured for storing a virtual item of the main control virtual character. The client may control (display), through a control operation performed by the first user account on the main control virtual character, the main control virtual character to use the virtual item in the virtual backpack of the main control virtual character. The virtual item is an item that can be used by the virtual character in the virtual environment, and includes, for example, an attack item, a defense item, a supplement item, and a virtual accessory.

The explosive virtual item is a virtual item that takes effect after exploding. In other words, the explosive virtual item may explode after being used. The explosive virtual item is a virtual item that produces an effect in an effective range, and the effective range is a range in which the effect is produced. In some aspects, the explosive virtual item has an effect on a virtual character hit in the effective range, and the explosive virtual item may hit at least one virtual character in the effective range. For example, the explosive virtual item may be at least one of the following virtual items: a grenade, a flash grenade, a smoke grenade, an incendiary grenade, a stun grenade, a missile, a rocket, or a jamming bomb.

The effective range of the explosive virtual item may be determined based on a preset configuration of the explosive virtual item. After the main control virtual character uses the explosive virtual item, causing the explosive virtual item to explode at an effective position, the effective range of the explosive virtual item may be determined based on the effective position and a pre-configured manner for determining the effective range of the explosive virtual item. In some aspects, the effective range of the explosive virtual item may be a two-dimensional area range, or may be a three-dimensional space range. For example, the explosive virtual item correspondingly has an effective radius, and the effective range of the explosive virtual item is defined by a spherical range with the effective position as a center and the effective radius as a radius. For another example, the explosive virtual item correspondingly has effective space. The effective position is used as an anchor point position of the effective space, and an orientation of the explosive virtual item at the effective position is used as an anchor point normal vector of the effective space, thereby determining the effective range of the explosive virtual item based on the effective space.

In some aspects, the explosive virtual item in the aspects of this disclosure may alternatively be a throwing virtual item. In other words, the explosive virtual item may explode after being thrown. The throwing virtual item is a virtual item used by the virtual character in the virtual environment by throwing. The throwing virtual item may be considered as a virtual attack item. The throwing virtual item is a throwable virtual object that can be used by the virtual character in the virtual environment. For example, division is performed based on functions. Throwing virtual items include a damage-type throwing virtual item and a non-damage-type throwing virtual item. The damage-type throwing virtual item may cause damage to a virtual character. The non-damage-type throwing virtual item does not cause damage to a virtual character, but causes functional impact. The throwing virtual item includes, but is not limited to, a virtual flying knife, a virtual flying ax, a virtual grenade, a virtual flash grenade, a virtual smoking grenade, a virtual mine, a virtual bomb, a virtual incendiary grenade, a virtual viscosity bomb, a virtual incendiary flask, and a virtual toxic smoke grenade. In some aspects, the main control virtual character carries at least one explosive virtual item.

A voiceprint is a sound wave spectrum image displayed by converting a sound signal into electromagnetic vibration. In some aspects, in a scenario in the real world, a voiceprint of each person is unique. Correspondingly, in a scenario of a virtual environment, a voiceprint of each virtual character may be set as unique. The voiceprint has at least one of the following features: a wave length, a frequency, intensity, or an amplitude.

For example, an explosive virtual item is configured to have a voiceprint indication function. After the virtual item having the voiceprint indication function hits a target virtual character, voiceprint indication information of the hit target virtual character is continuously exposed to the main control virtual character (item user). The voiceprint indication information is at least configured for indicating a source position of a take hit sound of the hit target virtual character, to indicate a position of the hit target virtual character.

For example, because there are various quantities and types of explosive virtual items, the voiceprint indication function may be configured for all or some of the explosive virtual items. In some aspects, only some explosive virtual items may be configured with the voiceprint indication function. When the main control virtual character uses an explosive virtual item configured with the voiceprint indication function, and the explosive virtual item hits a target virtual character, voiceprint indication information corresponding to the target virtual character may be displayed by using the method for displaying an item effect provided in the aspects of this disclosure. However, after an explosive virtual item not configured with the voiceprint indication function hits the target virtual character, the voiceprint indication information corresponding to the target virtual character is not displayed.

Operation 320: Display, in response to an item use operation, use of the explosive virtual item by the main control virtual character, the explosive virtual item being a virtual item producing an effect in the effective range. For example, an item use operation performed on an item control element in the user interface corresponding to the explosive virtual item is received. Based on the item use operation, the controlled virtual character using the explosive virtual item is output for display. The explosive virtual item is a virtual item that generates an effect within an effective range.

The item use operation is an operation of controlling the main control virtual character to use the explosive virtual item. The client displays, based on a control operation performed by the first user account on the main control virtual character, that the main control virtual character uses the explosive virtual item. The item use operation may be the main control virtual character throws the explosive virtual item. In some aspects, when the main control virtual character uses at least one explosive virtual item, the item use operation may be an operation of using the at least one explosive virtual item. For example, one explosive virtual item is thrown through one item use operation, or at least two explosive virtual items are thrown through one item use operation.

After the explosive virtual item is used, an effective range is generated in the virtual environment, and the effective range is further related to a direction and force of throwing the explosive virtual item. The first user account may control the direction and the force of throwing the explosive virtual item by the main control virtual character, to control the effective range of the explosive virtual item in the virtual environment.

In some aspects, a throwing manner of throwing the explosive virtual item includes at least one of high throwing, low throwing, or collision and rebound of the explosive virtual item. This is not limited in the aspects of this disclosure. In other words, the explosive virtual item may be used in at least one manner of high throwing, low throwing, or collision and rebound.

In some aspects, the explosive virtual item may be an item that takes effect immediately after being used, or may be an item that takes effect with a delay. Taking effect with a delay refers to taking effect after a period of time or after a condition is satisfied. The condition may be that there is a preset event, for example, a collision event. For example, the explosive virtual item may be a virtual grenade. The virtual grenade is an item whose exploding function is triggered when a duration for which the virtual grenade is thrown in the virtual environment reaches a preset duration. The first user account controls the main control virtual character to throw the virtual grenade. When the duration for which the virtual grenade is thrown reaches the preset duration, the client displays that the virtual grenade explodes in the virtual environment, and causes damage to a virtual character in a preset distance range of an explosion point. For another example, the explosive virtual item may be a virtual flash grenade. The virtual flash grenade is an item whose flash function is triggered when the virtual flash grenade is thrown in the virtual environment and is collided. The first user account controls the main control virtual character to throw the virtual flash grenade. When the virtual flash grenade lands in the virtual environment, the client triggers the flash function in a flash range of the virtual flash grenade, and a line of sight of a virtual character in the flash range is blocked.

Operation 330 : Display the voiceprint indication information corresponding to the target virtual character when the explosive virtual item acts on the target virtual character, the voiceprint indication information being configured for indicating the source position of the take hit sound caused by the action of the explosive virtual item. For example, whether the explosive virtual item acts on a target virtual character is determined. When the explosive virtual item acts on the target virtual character, voiceprint indication information that indicates a source position of a take-hit sound caused by the explosive virtual item acting on the target virtual character is output for display.

In an aspect, a manner of determining that the explosive virtual item acts on the target virtual character may include at least one of the following: determining, when the target virtual character is in the effective range of the explosive virtual item, that the explosive virtual item acts on the target virtual character; determining, when the target virtual character is in the effective range of the explosive virtual item and the target virtual character belongs to an enemy camp of the main control virtual character, that the explosive virtual item acts on the target virtual character; determining, when the target virtual character is in the effective range of the explosive virtual item and the explosive virtual item can directly hit the target virtual character, that the explosive virtual item acts on the target virtual character; or determining, when the target virtual character is in the effective range of the explosive virtual item and the target virtual character is a target character type of the explosive virtual item, that the explosive virtual item acts on the target virtual character.

In some aspects, the take hit sound is automatically made when the explosive virtual item produces the effect. For example, the take hit sound may be at least one of the following: an explosion sound or an explosion echo. Alternatively, the take hit sound is emitted by the target virtual character after the target virtual character is hit by the explosive virtual item. For example, the take hit sound is a help seeking sound of the target virtual character or a sound of collision with another object. For example, after the target virtual character is hit by the explosive virtual item, the take hit sound is made, and then the voiceprint indication information corresponding to the take hit sound is displayed in the interface of the main control virtual character. For example, the voiceprint indication information is indication information generated because the target virtual character makes a sound after the explosive virtual item acts on the target virtual character, and the position of the target virtual character is exposed to the item user (main control virtual character) through the source position of the sound made by the target virtual character.

The voiceprint indication information is item effect feedback information that is displayed to the item user (main control virtual character) when the explosive virtual item is configured with the voiceprint indication function and that indicates that the position of a target (target virtual character) is hit. The voiceprint indication information is configured for indicating the position of the virtual character hit by the explosive virtual item. The voiceprint indication information is configured for indicating a relative orientation and/or a relative distance between the virtual character hit by the explosive virtual item and the main control virtual character.

In some aspects, the voiceprint indication information may be displayed in at least one of the following forms: an icon, a control, a marked position, a diffused sound wave, or information in a text box. For example, the voiceprint indication information may be an icon displayed in the user interface, or the voiceprint indication information may be a UI control displayed in the user interface.

For example, the voiceprint indication information may be displayed on the orientation compass, an orientation of the target virtual character is determined based on a display position of the voiceprint indication information on the orientation compass, and the distance between the target virtual character and the main control virtual character is indicated based on a display size of the voiceprint indication information on the orientation compass.

Alternatively, the voiceprint indication information may be displayed as a pointing icon, the pointing icon is a three-dimensional icon displayed in the virtual environment, the pointing icon points to the position of the target virtual character in the virtual environment, and the distance between the target virtual character and the main control virtual character may further be displayed near the pointing icon.

Alternatively, the voiceprint indication information may be a marked position of the target virtual character on a small map/radar.

Alternatively, the voiceprint indication information may be displayed in a form of a sound wave in the virtual environment, the sound wave diffuses outward from the position of the target virtual character, and the main control virtual character may predict the position of the target virtual character based on a diffusion shape of the sound wave.

Alternatively, the voiceprint indication information may be displayed as a text box, and the text box displays at least one type of information indicated by the voiceprint indication information.

In some aspects, when the voiceprint indication information is displayed as a UI control, the first user account may further trigger the UI control to lock onto the target virtual character to launch a homing item, where the homing item may perform homing launch in real time based on the position indicated by the voiceprint indication information. When the UI control corresponding to the voiceprint indication information is selected, it is displayed, in response to an operation of using the homing item, that the main control virtual character locks the sound source position and launches the homing item, where the sound source position is the position indicated by the voiceprint indication information.

In some aspects, the voiceprint indication information may be configured for indicating at least one type of the following information: an absolute position (a coordinate position in the virtual environment) of the target virtual character, a relative direction of the target virtual character to the main control virtual character (namely, an orientation of the target virtual character relative to the main control virtual character), the relative distance between the target virtual character and the main control virtual character, an action degree (for example, a value of damage or a damage degree) of the target virtual character under the action of the explosive virtual item, an equipment status of the target virtual character (for example, whether defense equipment is worn, a defense value of the defense equipment, or a defense status), a quantity of virtual characters hit by the explosive virtual item, a camp to which the target virtual character belongs, or whether the target virtual character moves out of the effective range. In some examples, the voiceprint indication information is further configured for indicating at least one of the following information: a character type, gender, a current posture, or a level that are of the target virtual character.

In some aspects, there may be one or at least two target virtual characters hit by the explosive virtual item. For example, when the explosive virtual item hits one target virtual character, one piece of voiceprint indication information corresponding to the target virtual character is displayed in the user interface of the main control virtual character. When the explosive virtual item hits at least two target virtual characters, at least two pieces of voiceprint indication information respectively corresponding to the at least two target virtual characters are displayed in the user interface of the main control virtual character. In other words, one piece of voiceprint indication information is displayed for each target virtual character hit by the explosive virtual item. In this aspect of this disclosure, only the target virtual character is used as an example for description, and voiceprint indication information corresponding to another hit virtual character may be similarly displayed.

In some aspects, the voiceprint indication information may be displayed in the user interface of the main control virtual character for a period of time. A display duration of the voiceprint indication information may be a preset duration. Alternatively, the display duration of the voiceprint indication information may be determined based on at least one of the following information: a distance between the target virtual character and the effective position of the explosive virtual item, an action duration of the explosive virtual item, or a duration for which the target virtual character is in the effective range of the explosive virtual item.

For example, when the explosive virtual item hits the target virtual character, the display duration is determined based on a straight-line distance between the target virtual character and the effective position, and the voiceprint indication information is displayed in the user interface of the main control virtual character in the display duration. The display of the voiceprint indication information is canceled after the display duration expires.

For example, when the explosive virtual item hits the target virtual character, the voiceprint indication information corresponding to the target virtual character is displayed in the user interface of the main control virtual character. The voiceprint indication information is continuously displayed in the action duration in which the explosive virtual item takes effect when the target virtual character is in the effective range. The display of the voiceprint indication information is canceled after the action duration in which the explosive virtual item takes effect expires. The display of the voiceprint indication information is canceled after the target virtual character moves out of the effective range.

During continuous display of the voiceprint indication information, the voiceprint indication information changes with the position of the target virtual character, to indicate a current position of the target virtual character to the main control virtual character in real time.

Alternatively, the voiceprint indication information may be configured for indicating a position at which the target virtual character is hit, does not change with the position of the target virtual character, and points to the position at which the target virtual character is hit during the continuous display.

In an aspect, for example, the voiceprint indication information is displayed in a form of an icon, and the voiceprint indication information includes a voiceprint icon. The orientation compass is displayed in the user interface. The first terminal may display the voiceprint icon corresponding to the target virtual character on the orientation compass.

The voiceprint icon is configured for indicating at least one of a first direction or a first distance; a display position of the voiceprint icon on the orientation compass is configured for indicating the first direction of a position of the target virtual character relative to a position of the main control virtual character; and a display size of the voiceprint icon on the orientation compass is configured for indicating the first distance between the position of the target virtual character and the position of the main control virtual character.

For example, the voiceprint icon changes with the position of the target virtual character. In some aspects, the first terminal displays the voiceprint icon corresponding to the target virtual character on the orientation compass, and the voiceprint icon on the orientation compass changes with first information, where the first information includes at least one of the following: the position of the main control virtual character, the position of the target virtual character, or the orientation of the main control virtual character.

That the voiceprint icon on the orientation compass changes with the first information may indicate at least one of the following: the display position of the voiceprint icon on the orientation compass points to a direction in which the target virtual character is located; the voiceprint icon becomes larger when the distance between the target virtual character and the main control virtual character is decreased; or the voiceprint icon becomes smaller when the distance between the target virtual character and the main control virtual character is increased.

For example, if the target virtual character does not move, when the main control virtual character shifts the perspective to the right, the voiceprint icon moves leftwards on the orientation compass; or when the main control virtual character shifts the perspective to the left, the voiceprint icon moves rightwards on the orientation compass. If the target virtual character does not move, when the main control virtual character approaches the target virtual character, the voiceprint icon gradually becomes larger on the orientation compass; or when the main control virtual character moves away from the target virtual character, the voiceprint icon gradually becomes smaller on the orientation compass. If the main control virtual character does not move and does not shift the perspective, when the target virtual character moves to a left side of the main control virtual character, the voiceprint icon moves leftwards on the orientation compass; or when the target virtual character moves to a right side of the main control virtual character, the voiceprint icon moves rightwards on the orientation compass.

In some aspects, the voiceprint icon may further have at least two colors. Different colors of the at least two colors are configured for indicating the damage degree of the target virtual character, different colors of the at least two colors are configured for indicating the defense status of the target virtual character, or different colors of the at least two colors are configured for indicating the current posture of the target virtual character.

For example, when the value of damage caused by the explosive virtual item to the target virtual character is less than a first threshold, the voiceprint icon is displayed in green; when the value of damage caused by the explosive virtual item to the target virtual character is greater than the first threshold, the voiceprint icon is displayed in yellow; or when the target virtual character is killed by the explosive virtual item, the voiceprint icon is displayed in red.

Alternatively, when the target virtual character does not wear defense equipment, the voiceprint icon is displayed in orange; or when the target virtual character wears the defense equipment, the voiceprint icon is displayed in blue.

Alternatively, when the target virtual character is in a standing posture, the voiceprint icon is displayed in white; when the target virtual character is in a kneeling posture, the voiceprint icon is displayed in pink; or when the target virtual character is in a prone posture, the voiceprint icon is displayed in black.

In some aspects, the voiceprint icon may further have at least two shapes. Different shapes of the at least two shapes are configured for indicating the level of the target virtual character, different shapes of the at least two shapes are configured for indicating the gender of the target virtual character, different shapes of the at least two shapes are configured for indicating the camp to which the target virtual character belongs, or different shapes of the at least two shapes are configured for indicating the current posture of the target virtual character.

For example, when the target virtual character is in the standing posture, the voiceprint icon is displayed in a standing style; when the target virtual character is in the kneeling posture, the voiceprint icon is displayed in a kneeling style; or when the target virtual character is in the prone posture, the voiceprint icon is displayed in a prone style.

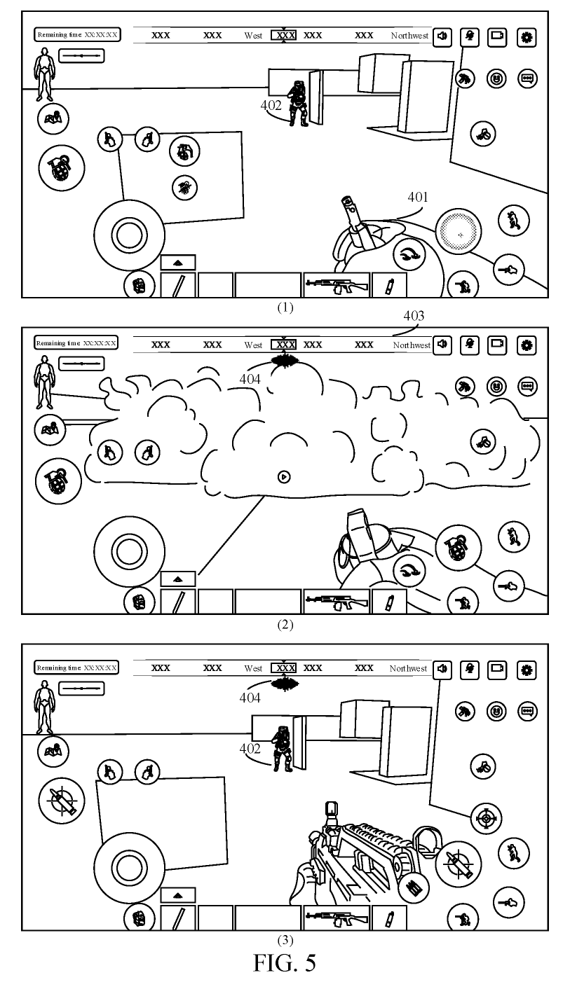

For example, the explosive virtual item is a grenade. As shown in (1) in FIG. 5, a user interface is displayed, a virtual environment picture in the user interface is a picture of a virtual environment observed from a first-person perspective of a main control virtual character 401, and the main control virtual character 401 may hold the grenade (explosive virtual item). A target virtual character 402 may further be displayed in the virtual environment picture of the user interface.

Subsequently, a user account may control the main control virtual character 401 to throw the grenade to the target virtual character. As shown in (2) in FIG. 5, the grenade explodes near the target virtual character. The target virtual character makes a take hit sound after being hit, and a voiceprint icon 404 is displayed at a position of the target virtual character on an orientation compass 403.

As shown in (3) in FIG. 5, the voiceprint icon 404 may be displayed in the interface for a period of time, to continuously indicate a real-time position of the target virtual character 402 to the main control virtual character.

In an aspect, when the main control virtual character cannot directly see the target virtual character, voiceprint indication information may be displayed. When the main control virtual character can directly see the target virtual character, the voiceprint indication information is not displayed, and an outline of the target virtual character is highlighted.

For example, when the explosive virtual item acts on the target virtual character, and the target virtual character is in the virtual environment picture of the main control virtual character (it may be that the target virtual character is fully displayed in the virtual environment picture, that is, is not blocked at all; or it may be that the target virtual character is partially displayed in the virtual environment picture, that is, is partially blocked), the outline of the target virtual character is highlighted. When the explosive virtual item acts on the target virtual character, and the target virtual character is not in the virtual environment picture of the main control virtual character, the voiceprint indication information corresponding to the target virtual character is displayed.

The voiceprint indication information is information displayed to the item user (main control virtual character), and the information is not displayed in user interfaces of non–item users (including a hit virtual character and a virtual character not hit). For example, the voiceprint indication information is not displayed in a user interface from the perspective of the target virtual character. For another example, the voiceprint indication information is not displayed in a user interface of a third virtual character, and the third virtual character does not hit the target virtual character by using an explosive virtual item.

Alternatively, the voiceprint indication information may be synchronously displayed to virtual characters of the current camp. For example, the third virtual character and the main control virtual character belong to the same camp. After the main control virtual character hits the target virtual character by using the explosive virtual item, the voiceprint indication information is synchronously displayed in the user interface corresponding to the third virtual character. The voiceprint indication information in the user interface of the third virtual character is displayed based on a relative position of the third virtual character to the target virtual character, and is configured for indicating the position of the target virtual character to the third virtual character.

Based on the above, according to the method for displaying an item effect provided in the aspects, the voiceprint indication function is set for the explosive virtual item. After the main control virtual character hits the target virtual character by using the explosive virtual item, the voiceprint indication information of the target virtual character is exposed to the main control virtual character (item user) based on the take hit sound of the target virtual character. The voiceprint indication information is configured for indicating the position of the target virtual character. Sound localization in reality can be simulated by using the voiceprint indication information, to indicate the position of the target virtual character to the main control virtual character, and the main control virtual character may further explore based on the voiceprint indication information, thereby improving man-machine interaction efficiency.

According to the method for displaying an item effect provided in the aspects, after the explosive virtual item hits the target virtual character, the voiceprint icon corresponding to the target virtual character is displayed on the orientation compass, the orientation of the target virtual character relative to the main control virtual character is marked by using the position of the voiceprint icon on the orientation compass, and the display size of the voiceprint icon is configured for representing the distance between the target virtual character and the main control virtual character. It is convenient for the main control virtual character to determine the position of the target virtual character.

According to the method for displaying an item effect provided in the aspects, the voiceprint icon may continuously indicate the real-time position of the target virtual character to the main control virtual character in a period of time, and the position and the size of the voiceprint icon on the orientation compass may change with the relative position of the target virtual character to the main control virtual character, so that the main control virtual character can position the target virtual character in real time.

In a game scenario, when the user account encounters an obstacle like a house, a wall, or a rock in a virtual environment, the user account is concerned about whether an enemy is hidden behind the obstacle. Therefore, the user account throws a virtual item near the obstacle to make a test. However, when the enemy remains latent, even when the user account throws the virtual item, the user account cannot accurately determine whether there is an enemy behind the obstacle, and cannot exclude a risk that there is an enemy latent behind the obstacle. Therefore, according to the method for displaying an item effect provided in the aspects of this disclosure, after the user account controls the main control virtual character to throw the explosive virtual item behind the obstacle, if the explosive virtual item hits an enemy, voiceprint indication information of the enemy is displayed in the user interface of the main control virtual character, to remind the user account that the enemy is latent behind the obstacle, and a position of the enemy is indicated to the user account by using the voiceprint indication information.

In some aspects, a take hit animation may be displayed after the target virtual character is hit. In some aspects, after the target virtual character is hit, a take hit animation action may be performed, to display the take hit animation.

In some aspects, the display duration of the voiceprint indication information may be determined based on the distance between the target virtual character and the effective position.

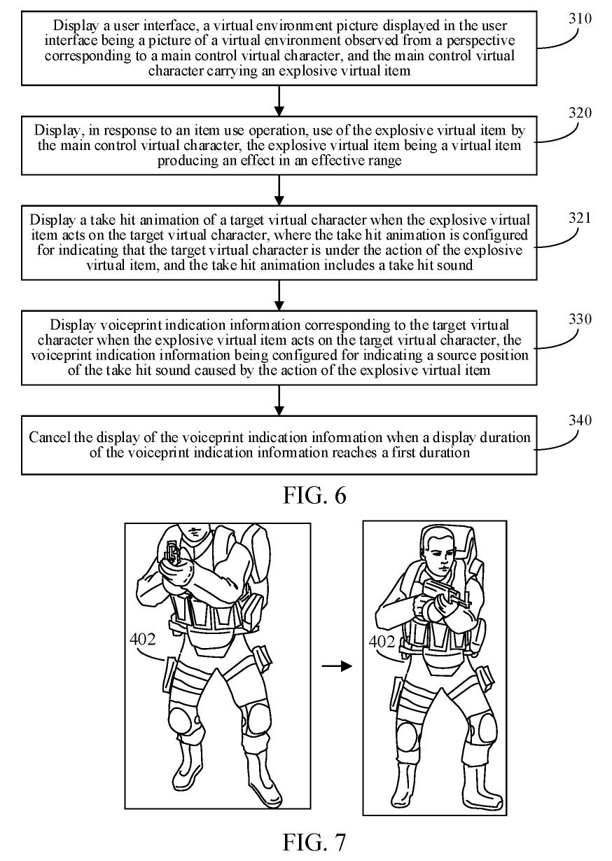

FIG. 6 is a schematic flowchart of a method for displaying an item effect according to an aspect of this disclosure. The method may be performed by a computer device. The computer device may be a terminal. For example, the method may be applied to the terminal shown in FIG. 1 or the client supporting a virtual environment in the terminal, or may be applied to the first terminal in the system shown in FIG. 2 or the client supporting a virtual environment in the first terminal. Based on the aspect shown in FIG. 3, before operation 330, operation 321 is further included, and/or after operation 330, operation 340 is further included.

Operation 310 : Display a user interface, a virtual environment picture displayed in the user interface being a picture of a virtual environment observed from a perspective corresponding to a main control virtual character, and the main control virtual character carrying an explosive virtual item.

Operation 320: Display, in response to an item use operation, use of the explosive virtual item by the main control virtual character, the explosive virtual item being a virtual item producing an effect in an effective range.

Operation 321: Display a take hit animation of a target virtual character when the explosive virtual item acts on the target virtual character, where the take hit animation is configured for indicating that the target virtual character is under the action of the explosive virtual item, and the take hit animation includes a take hit sound. For example, a take-hit animation of the target virtual character is output for display when the explosive virtual item acts on the target virtual character. The take-hit animation indicates that the explosive virtual item acts on the target virtual character, and the take-hit animation includes the take-hit sound.

When the explosive virtual item hits the target virtual character, the explosive virtual item acts on the target virtual character, so that playing of a take hit animation is triggered, where the take hit animation includes at least the take hit sound. The take hit animation is a take hit animation corresponding to the explosive virtual item. Different take hit animations may be played when different explosive virtual items hit the target virtual character.

The take hit animation, the take hit sound, and a voiceprint indication function may be separately configured. Not all explosive virtual items have a take hit animation and a take hit sound after hitting the target virtual character, and an explosive virtual item having a take hit animation may not be configured with a voiceprint indication function either. Such capabilities may be independently configured (For example, an explosive virtual item may not have a take hit animation but have a voiceprint indication function, or may have a take hit animation but not have a voiceprint indication function).

To enrich performance of the target virtual character when under the action of the explosive virtual item, and to make an effect of "voiceprint exposure" of the target virtual character more proper and in line with recognition of players, some performance details are added in the method for displaying an item effect provided in the aspects of this disclosure In the method for displaying an item effect provided in the aspects of this disclosure, the "take hit animation" is configured for representing this design point. The take hit animation is configured for showing that the target virtual character hit through explosion is unable to stand steadily due to a shockwave of the explosive, and thus accidentally "makes a sound", thereby exposing voiceprint indication information.

For example, as shown in FIG. 7, when a target virtual character 402 is hit by an explosive virtual item through explosion, legs of the target virtual character 402 are inflected outward, a body of the target virtual character 402 is inclined, and a take hit animation is played.

In some aspects, a playback duration of the take hit animation/take hit sound may not be necessarily related to the display duration of the voiceprint indication information. For example, the playback duration of the take hit sound is a first duration, the display duration of the voiceprint indication information is a second duration, the first duration may be equal to the second duration, the first duration may be greater than the second duration, or the first duration may be less than the second duration.

For example, different take hit animations may be configured for different explosive virtual items, and the explosive virtual items are in a one-to-one correspondence with the take hit animations. The target virtual character is controlled, based an explosive virtual item hitting the target virtual character, to perform a take hit animation action corresponding to the explosive virtual item, to display a take hit animation.

For example, clients of all or some virtual characters (including the main control virtual character, the target virtual character, and the third virtual character) participating in this game match may display that the target virtual character performs the take hit animation action after being hit by the explosive virtual item. However, only a client (user interface) of the main control virtual character displays the voiceprint indication information.

Operation 330 : Display the voiceprint indication information corresponding to the target virtual character when the explosive virtual item acts on the target virtual character, the voiceprint indication information being configured for indicating a source position of the take hit sound caused by the action of the explosive virtual item.

For example, when the take hit animation is played, the voiceprint indication information corresponding to the target virtual character is displayed, so that a user account can see the voiceprint indication information in the interface while hearing the take hit sound, and the source position of the take hit sound is displayed to the user account.

Operation 340: Cancel the display of the voiceprint indication information when the display duration of the voiceprint indication information reaches a first duration. For example, the display of the voiceprint indication information is cancelled when a display duration of the voiceprint indication information reaches a threshold duration. The threshold duration has a negative correlation with a distance between the target virtual character and an effect position of the explosive virtual item.

The first duration has a negative correlation with a straight-line distance, and the straight-line distance is a distance between the target virtual character and an effective position of the explosive virtual item.

For example, the voiceprint indication information correspondingly has the display duration. When the display duration of the voiceprint indication information reaches a specified value (for example, the first duration), the display of the voiceprint indication information is canceled. The first duration is determined based on the straight-line distance between the target virtual character and the effective position. A longer distance between the target virtual character and the effective position indicates a shorter display duration of the voiceprint indication information. A shorter distance between the target virtual character and the effective position indicates a longer display duration of the voiceprint indication information.

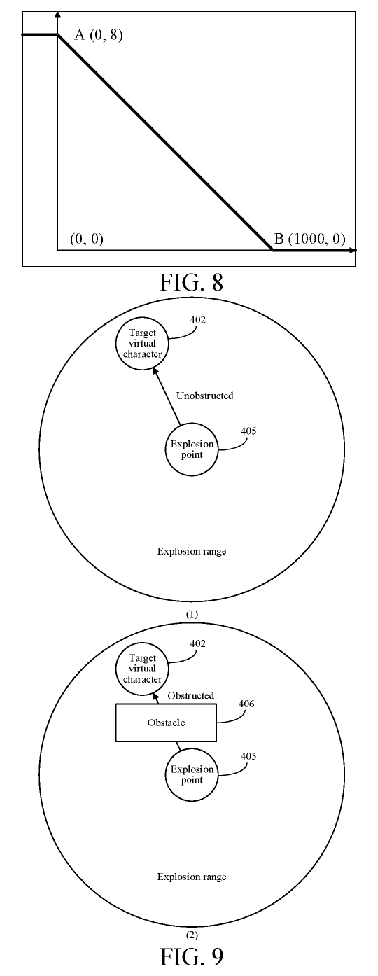

In some aspects, a relationship between the display duration of the voiceprint indication information and the straight-line distance may be determined based on a preset relationship curve. For example, FIG. 8 shows a relationship curve of a display duration and a straight-line distance. A horizontal axis of the relationship curve is a straight-line distance (centimeter), namely, a straight-line distance between a virtual character hit through explosion and a center of the explosion. A vertical axis of the relationship curve is a display duration (seconds), namely, an exposure duration of corresponding voiceprint indication information after the target virtual character is under the action of the explosion at the distance. A point (0, 8) in FIG. 8 indicates that under the action of the explosive virtual item at a distance of 0 cm, the voiceprint indication information may be continuously displayed for 8s. A point B (1000, 0) in FIG. 8 indicates that under the action of the explosive virtual item at a distance of 1000 cm, the voiceprint indication information may be continuously displayed for 0s, in other words, no voiceprint indication information is displayed. A value of the horizontal coordinate of the point B may depend on a radius of an effective range corresponding to the explosive virtual item. For example, when the radius of the effective range is 1000 cm, at a position of 1000 cm or beyond, the explosive virtual item does not have an effect, and no voiceprint indication information is displayed.

In an aspect, when there is an obstacle between the target virtual character and the effective position, the straight-line distance may be a route distance for navigating from the effective position to the position of the target virtual character, or the straight-line distance may be a diffusion distance by which the effect of the explosive virtual item diffuses from the effective position to the position of the target virtual character. In this way, the display duration of the voiceprint indication information can be closer to an actual effect of the explosive virtual item.

Based on the above, according to the method for displaying an item effect provided in the aspects, after the target virtual character is hit by the explosive virtual item, the take hit animation in which the target virtual character is hit is played. The take hit animation includes the take hit sound, and the voiceprint indication information is displayed in the user interface of the main control virtual character, to display the source position of the take hit sound to the user account. The position of the target virtual character is indicated by the voiceprint indication information, to simulate sound localization in reality, and provide the main control virtual character (item user) with an indication of the position of the target virtual character (take hit character).

According to the method for displaying an item effect provided in the aspects, the display duration of the voiceprint indication information is determined based on the straight-line distance between the target virtual character and the effective position of the explosive virtual item, so that the voiceprint indication information of the target virtual character close to an explosion point is exposed for a longer time, and the voiceprint indication information of the target virtual character far away from the explosion point is exposed for a short time, thereby giving the target virtual character and a main control virtual character certain information game space.

For example, according to different action manners of explosive virtual items, the explosive virtual items may be divided into a direct virtual item and an indirect virtual item. The direct virtual item is an explosive virtual item that can directly hit a virtual character, and the indirect virtual item is an explosive virtual item that can penetrate an obstacle and hit a virtual character.

For example, as shown in (1) in FIG. 9, an explosive virtual item takes effect at an explosion point (effective position) 405, a target virtual character 402 is located in an explosion range (effective range), and there is no obstruction between the explosion point 405 and the target virtual character 402. In this case, a direct virtual item may act on the target virtual character 402, and an indirect virtual item may also act on the target virtual character 402.

As shown in (2) in FIG. 9, the explosive virtual item takes effect at the explosion point (effective position) 405, the target virtual character 402 is in explosion range (effective range). However, there is an obstacle 406 between the explosion point 405 and the target virtual character 402, and the target virtual character 402 is obstructed by the obstacle 406. In this case, a direct virtual item cannot act on the target virtual character 402, and an indirect virtual item can act on the target virtual character 402.

The method for displaying an item effect provided in the aspects of this disclosure is described below by using a direct virtual item and an indirect virtual item respectively as examples for description.

1. Direct virtual item.

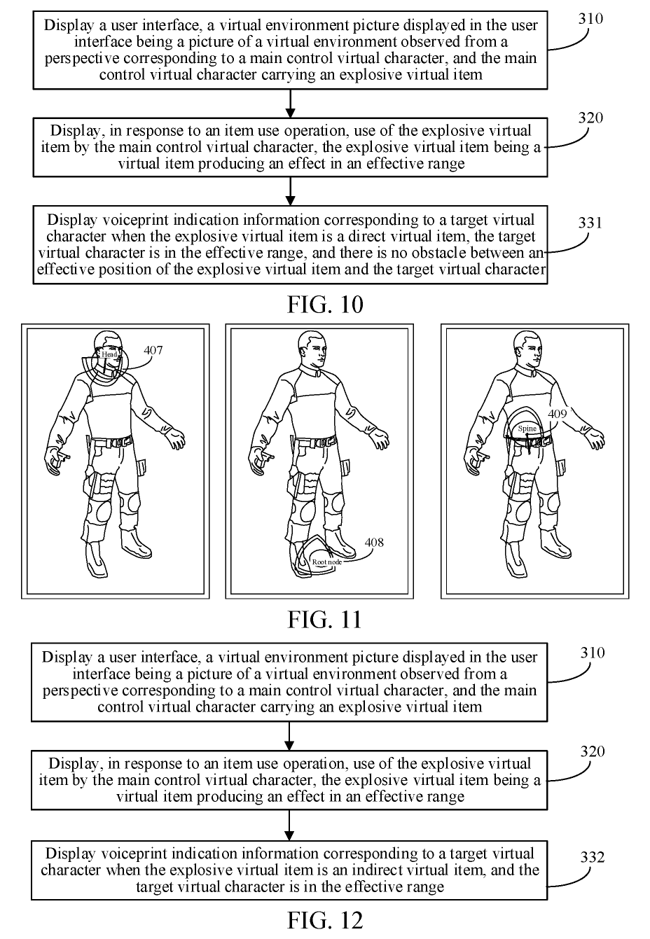

FIG. 10 is a schematic flowchart of a method for displaying an item effect according to an aspect of this disclosure. The method may be performed by a computer device. The computer device may be a terminal. For example, the method may be applied to the terminal shown in FIG. 1 or the client supporting a virtual environment in the terminal, or may be applied to the first terminal in the system shown in FIG. 2 or the client supporting a virtual environment in the first terminal. Based on the aspect shown in FIG. 3, operation 330 includes operation 331.

Operation 310 : Display a user interface, a virtual environment picture displayed in the user interface being a picture of a virtual environment observed from a perspective corresponding to a main control virtual character, and the main control virtual character carrying an explosive virtual item.

For example, the explosive virtual item is a direct virtual item, and the direct virtual item is a virtual item acting on a virtual character that is in an effective range and between which and an effective position there is no obstacle.

The direct virtual item may also be referred to as a virtual item that can perform direct hitting. The direct virtual item can hit a target when there is no obstacle between the effective position and a hit target (target virtual character). For example, the direct virtual item may include: a grenade, a flash grenade, or the like.

Operation 320: Display, in response to an item use operation, use of the explosive virtual item by the main control virtual character, the explosive virtual item being a virtual item producing an effect in the effective range.

Operation 331 : Display voiceprint indication information corresponding to the target virtual character when the explosive virtual item is a direct virtual item, the target virtual character is in the effective range, and there is no obstacle between the effective position of the explosive virtual item and the target virtual character. For example, the explosive virtual item is a direct-hit virtual item that acts on the target virtual character when the target virtual character is located within the effective range and no obstacle exists between an effect position of the explosive virtual item and the target virtual character.

When the explosive virtual item is a direct virtual item, the explosive virtual item can hit the target virtual character when there is no obstacle between the target virtual character and the effective position.

In some aspects, when the explosive virtual item is a direct virtual item, a straight-line distance between the effective position of the explosive virtual item and the target virtual character is calculated. At least one detection line is emitted from the effective position to a key joint point of the target virtual character when the straight-line distance is less than an effective radius of the explosive virtual item. When no obstacle is detected at the at least one detection line, the explosive virtual item is determined to act on the target virtual character. The voiceprint indication information corresponding to the target virtual character is displayed, where the key joint point includes at least one of the following: a head joint point, a chest joint point, a hip joint point, a leg joint point, a foot joint point, a spine joint node, or a root node.

For example, as shown in FIG. 11, the target virtual character may include three key joint points (key skeleton points): a head joint point 407, a root node 408, and a spine joint point 409. These key joint points represent three key parts of the target virtual character: a head, a chest, and legs. When a detection ray (detection line/straight line) is emitted from an explosion point (effective position) to each of the three key joint points, and the detection rays corresponding to the three key joint points are not obstructed by obstacles, it indicates that there is no obstacle between the target virtual character and the explosion point.

In an aspect, the key joint points may alternatively be determined based on a current posture of the target virtual character. The posture includes at least one of the following: a standing posture, a kneeling posture, or a prone posture. When the target virtual character is currently in the standing posture, the key joint points may include the head joint point, the root node, and the spine joint point. When the target virtual character is currently in the kneeling posture, the key joint points may include the head joint point and the root node. When the target virtual character is currently in the prone posture, the key joint point may include the spine joint point.

For example, when the target virtual character is in the standing posture, from the effective position, a first detection line is emitted to the head joint point of the target virtual character, a second detection line is emitted to the root node of the target virtual character, and a third detection line is emitted to the spine joint point of the target virtual character. When no obstacle is detected at at least one of the first detection line, the second detection line, or the third detection line, the target virtual character in the standing posture is determined to be hit by the explosive virtual item (that is, the explosive virtual item is determined to act on the target virtual character). When an obstacle is detected at each of the first detection line, the second detection line, and the third detection line, the target virtual character in the standing posture is determined not to be hit by the explosive virtual item.

For example, when the target virtual character is in the kneeling posture, from the effective position, a first detection line is emitted to the head joint point of the target virtual character, and a second detection line is emitted to the root node of the target virtual character. When no obstacle is detected at one of the first detection line or the second detection line, the target virtual character in the kneeling posture is determined to be hit by the explosive virtual item (that is, the explosive virtual item is determined to act on the target virtual character). When an obstacle is detected at both the first detection line and the second detection line, the target virtual character in the kneeling posture is determined not to be hit by the explosive virtual item.

For example, when the target virtual character is in the prone posture, a third detection line is emitted from the effective position to the spine joint point of the target virtual character. When no obstacle is detected at the third detection line, the target virtual character in the prone posture is determined to be hit by the explosive virtual item (that is, the explosive virtual item is determined to act on the target virtual character). When an obstacle is detected at the third detection line, the target virtual character in the prone posture is determined not to be hit by the explosive virtual item.

Based on the above, according to the method for displaying an item effect provided in the aspects, when the explosive virtual item is a direct virtual item, whether the explosive virtual item can hit the target virtual character is detected by emitting a detection line. When the explosive virtual item can hit the target virtual character, the voiceprint indication information is configured for indicating a position of the target virtual character, to simulate sound localization in reality, and provide the main control virtual character with an indication of the position of the target virtual character.

2. Indirect virtual item.

FIG. 12 is a schematic flowchart of a method for displaying an item effect according to an aspect of this disclosure. The method may be performed by a computer device. The computer device may be a terminal. For example, the method may be applied to the terminal shown in FIG. 1 or the client supporting a virtual environment in the terminal, or may be applied to the first terminal in the system shown in FIG. 2 or the client supporting a virtual environment in the first terminal. Based on the aspect shown in FIG. 3, operation 330 includes operation 332.

Operation 310 : Display a user interface, a virtual environment picture displayed in the user interface being a picture of a virtual environment observed from a perspective corresponding to a main control virtual character, and the main control virtual character carrying an explosive virtual item.

For example, the explosive virtual item may be an indirect virtual item. The indirect virtual item is a virtual item that penetrates an obstacle and acts on a virtual character in an effective range. In other words, the indirect virtual item is a virtual item that has a capability of penetrating an obstacle and acts on a virtual character in an effective range.

The indirect virtual item may also be referred to as a virtual item that is allowed to perform indirect hitting. The indirect virtual item may hit a target virtual character when there is no obstacle between an effective position and a hit target (target virtual character), or may hit the target virtual character when there is an obstacle between the effective position and the hit target (target virtual character). For example, the indirect virtual item may include a stun grenade, a smoke grenade, or the like.

Operation 320: Display, in response to an item use operation, use of the explosive virtual item by the main control virtual character, the explosive virtual item being a virtual item producing an effect in the effective range.

Operation 332 : Display voiceprint indication information corresponding to the target virtual character when the explosive virtual item is an indirect virtual item, and the target virtual character is in the effective range. For example, the explosive virtual item is an indirect-hit virtual item that passes through an obstacle between an effect position of the explosive virtual item and the target virtual character, and acts on the target virtual character within the effective range.

When the explosive virtual item is an indirect virtual item, the explosive virtual item can hit the target virtual character as long as the target virtual character is in the effective range of the explosive virtual item.

In some aspects, when the explosive virtual item is an indirect virtual item, a straight-line distance between the effective position of the explosive virtual item and the target virtual character is calculated. When the straight-line distance is less than an effective radius of the explosive virtual item, it is determined that the explosive virtual item acts on the target virtual character. The voiceprint indication information corresponding to the target virtual character is displayed.

Based on the above, according to the method for displaying an item effect provided in the aspects, when the explosive virtual item is an indirect virtual item, whether the explosive virtual item can hit the target virtual character is detected by determining whether the distance between the target virtual character and the effective position is less than the effective radius of the explosive virtual item. When the explosive virtual item can hit the target virtual character, the voiceprint indication information is configured for indicating a position of the target virtual character, to simulate sound localization in reality, and provide the main control virtual character with an indication of the position of the target virtual character.

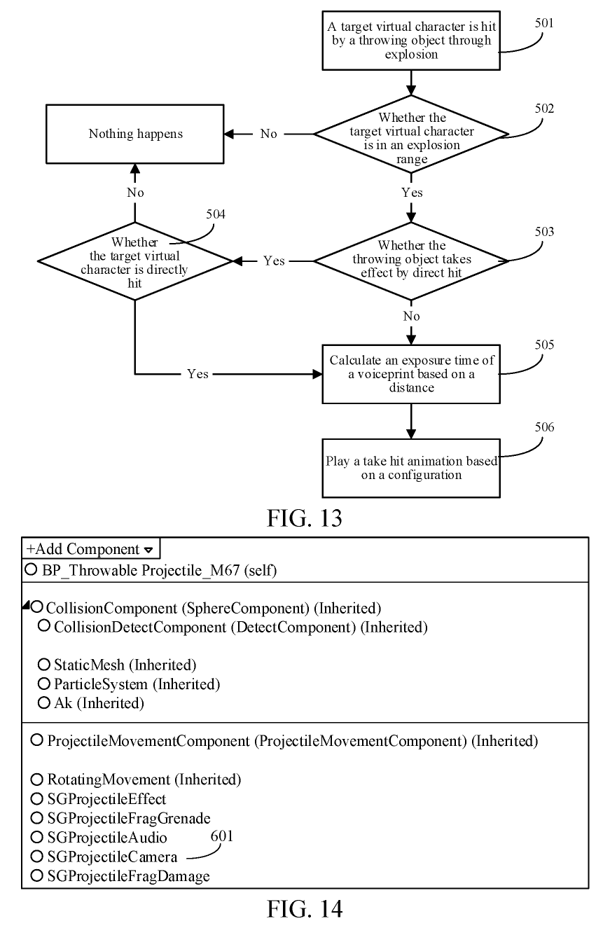

FIG. 13 is a schematic flowchart of a method for displaying an item effect according to an aspect of this disclosure. The method may be performed by a computer device. The computer device may be a terminal. For example, the method may be applied to the terminal shown in FIG. 1 or the client supporting a virtual environment in the terminal, or may be applied to the first terminal in the system shown in FIG. 2 or the client supporting a virtual environment in the first terminal. The method includes the following operations:

Operation 501: A user account controls a main control virtual character to throw at least one throwing object (explosive virtual item), and a target virtual character is hit by the throwing object through explosion.

For example, to facilitate configuring a voiceprint indication function for each throwing object at any time, the function is made into an integrated functional component form. As shown in FIG. 14, a yellow SGProjectileCamera (SG projection camera) component 601 is a component of this function. As long as this component 601 is added to a blueprint of the throwing object, it is considered that this function (voiceprint indication function) is enabled for the throwing object. The function can be configured at any time and canceled at any time, which is flexible in application.

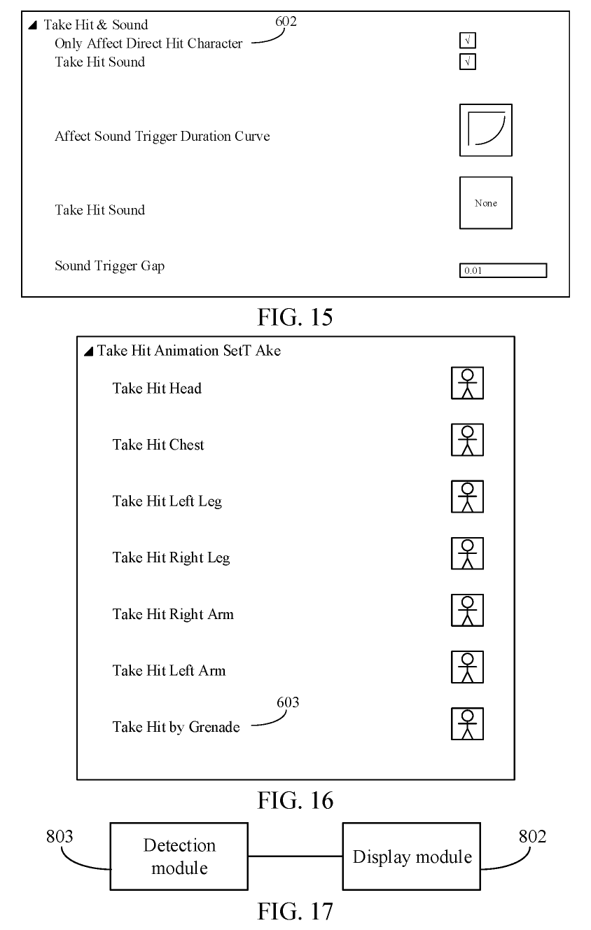

For example, as shown in FIG. 15, after an option 602 of "Only Affect Direct Hit Character" is checked in the blueprint of the throwing object for which the voiceprint indication function is enabled, the throwing object is set to "Take Effect Only by Direct Hit (Unobstructed)", namely, a direct virtual item. However, when the option 602 is not checked, the throwing object is considered as "Take Effect by Both Direct Hit and Hit through Wall", namely, an indirect virtual item.

For example, as shown in FIG. 16, a take hit logic after hitting by the throwing object is added, and a type of take hit "Take Hit by Grenade" 603 is newly added to "Take hit animation SetT Ake", namely, a type of hitting by a grenade. Various take hit animations after hitting by the throwing object may be flexibly configured herein.

Operation 502: Determine whether the target virtual character is in an explosion range (effective range) of the throwing object. If the target virtual character is in the explosion range, operation 503 is performed; otherwise, the process ends.

In some aspects, a detection ray is emitted from an effective position of the explosive virtual item to a root node of the target virtual character. A distance between the effective position and the root node is calculated by the detection ray. If the distance is less than an effective radius of the explosive virtual item, it is determined that the target virtual character is in the effective range; or if the distance is greater than the effective radius, it is determined that the target virtual character is not in the effective range.

Operation 503: Determine whether the throwing object can take effect only by direct hit; and if the throwing object can take effect only by direct hit, operation 504 is performed; otherwise, operation 505 is performed.

For example, a throwing object acts on a virtual character in two trigger scenarios:
1. The throwing object directly hits the virtual character through explosion. For example, in an explosion range of the throwing object, a connection line to a body center of the virtual character is not obstructed in any scenario. This trigger scenario is usually applied to a throwing object of an explosive damage type and a throwing object of a flash grenade type, because these two types of throwing objects require an immediate and tangible effect.
2. The throwing object affects the virtual character through a wall. For example, in an explosion range of the throwing object, although a connection line to a body center of the virtual character is obstructed in a scenario, the throwing object still takes effect. This trigger scenario is usually applied to a throwing object of a stun grenade type

In the aspects of this disclosure, a virtual item that can only directly hit a virtual character through explosion is referred to as a direct virtual item, and a virtual item that can affect a virtual character through a wall is referred to as an indirect virtual item.

If the explosive virtual item is a direct virtual item, the explosive virtual item can, and can only in some aspects, take effect by direct hit; or if the explosive virtual item is an indirect virtual item, the explosive virtual item can take effect by indirect hit.

Operation 504: Determine whether the target virtual character is directly hit by the throwing object; and if the target virtual character is directly hit by the throwing object, operation 505 is performed; otherwise, the process ends.

If the explosive virtual item is a direct virtual item, whether the explosive virtual item directly hits the target virtual character is further determined. Three detection lines are respectively emitted from the effective position to three key joint points of the target virtual character. If no obstacle is detected at at least one of the three detection lines, the target virtual character can be directly hit by the explosive virtual item; or if an obstacle is detected at each of the three detection lines, the target virtual character cannot be directly hit by the explosive virtual item.

Operation 505: Calculate an exposure time (display duration) of voiceprint indication information based on a distance between the target virtual character and an explosion point.

When the target virtual character is in the effective range, and the explosive virtual item is an indirect virtual item, the explosive virtual item can hit the target virtual character. In this case, a straight-line distance between the target virtual character and the effective position is calculated, and the display duration of the voiceprint indication information is determined based on the straight-line distance.

When the target virtual character is in the effective range, the explosive virtual item is a direct virtual item, and the explosive virtual item can directly hit the target virtual character, a straight-line distance between the target virtual character and the effective position is calculated, and the display duration of the voiceprint indication information is determined based on the straight-line distance.

Operation 506: Display the voiceprint indication information based on the exposure time, and play a take hit animation of the target virtual character based on a configuration.

As shown in FIG. 5, after the throwing object is thrown and hits the target virtual character through explosion, a voiceprint is left in the interface of the main control virtual character throwing the tactical item. The voiceprint is made by the target virtual character due to an effect of the throwing object. A position relationship of the voiceprint on the orientation compass (a left-right relationship between the voiceprint and the orientation compass) can reflect an orientation of the target virtual character hit through explosion.

Based on the above, according to the method for displaying an item effect provided in the aspects, a voiceprint indication function, an effective logic, and a take hit animation may be configured for each explosive virtual item, so that after the explosive virtual item hits the target virtual character, the voiceprint indication information of the target virtual character (take hit character) is exposed to the main control virtual character (item user) based on the take hit sound of the target virtual character, and the position of the target virtual character is indicated by the voiceprint indication information, to simulate sound localization in reality, and indicate the position of the target virtual character to the main control virtual character.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (for example, computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

A sequence of the operations of the method for displaying an item effect provided in the aspects of this disclosure may be adjusted, and the operations may alternatively be correspondingly added or deleted based on a situation.

FIG. 17 is a schematic structural diagram of an apparatus for displaying an item effect according to an aspect of this disclosure. As shown in FIG. 17, the apparatus includes:

a display module 802, configured to display a user interface, a virtual environment picture displayed in the user interface being a picture of a virtual environment observed from a perspective corresponding to a main control virtual character, and the main control virtual character carrying an explosive virtual item;

the display module 802 being configured to display, in response to an item use operation, use of the explosive virtual item by the main control virtual character, the explosive virtual item being a virtual item producing an effect in an effective range; and

the display module 802 being configured to display voiceprint indication information corresponding to a target virtual character when the explosive virtual item acts on the target virtual character, the voiceprint indication information being configured for indicating a source position of a take hit sound caused by the action of the explosive virtual item.

In an aspect, the voiceprint indication information includes a voiceprint icon; and an orientation compass is further displayed in the user interface; and

the display module 802 is configured to display the voiceprint icon corresponding to the target virtual character on the orientation compass, where

the voiceprint icon is configured for indicating at least one of a first direction or a first distance; a display position of the voiceprint icon on the orientation compass is configured for indicating the first direction of a position of the target virtual character relative to a position of the main control virtual character; and a display size of the voiceprint icon on the orientation compass is configured for indicating the first distance between the position of the target virtual character and the position of the main control virtual character.

In an aspect, the display module 802 is configured to display the voiceprint icon corresponding to the target virtual character on the orientation compass, where the voiceprint icon on the orientation compass changes with first information, and the first information includes at least one of the following: the position of the main control virtual character, the position of the target virtual character, or an orientation of the main control virtual character, where

that the voiceprint icon on the orientation compass changes with first information includes at least one of the following:

the display position of the voiceprint icon on the orientation compass points to a direction in which the target virtual character is located;

the voiceprint icon becomes larger when the distance between the target virtual character and the main control virtual character is decreased; and

the voiceprint icon becomes smaller when the distance between the target virtual character and the main control virtual character is increased.

In an aspect, the display module 802 is configured to display the voiceprint indication information corresponding to the target virtual character when the explosive virtual item is a direct virtual item, the target virtual character is in the effective range, and there is no obstacle between an effective position of the explosive virtual item and the target virtual character, where

the direct virtual item is a virtual item acting on a virtual character that is in the effective range and between which and the effective position there is no obstacle.

In an aspect, the apparatus further includes:

a detection module 803, configured to calculate a straight-line distance between the effective position of the explosive virtual item and the target virtual character when the explosive virtual item is the direct virtual item;

the detection module 803 being configured to emit at least one detection line from the effective position to a key joint point of the target virtual character when the straight-line distance is less than an effective radius of the explosive virtual item;

the detection module 803 being configured to determine, when no obstacle is detected at the at least one detection line, that the explosive virtual item acts on the target virtual character; and

the display module 802 being configured to display the voiceprint indication information corresponding to the target virtual character, where

the key joint point includes at least one of the following: a head joint point, a chest joint point, a hip joint point, a leg joint point, or a foot joint point.

In an aspect, the display module 802 is configured to display the voiceprint indication information corresponding to the target virtual character when the explosive virtual item is an indirect virtual item, and the target virtual character is in the effective range, where

the indirect virtual item is a virtual item that penetrates an obstacle and acts on a virtual character in the effective range.

In an aspect, the apparatus further includes:

a detection module 803, configured to calculate a straight-line distance between the effective position of the explosive virtual item and the target virtual character when the explosive virtual item is the indirect virtual item;

the detection module 803 being configured to determine, when the straight-line distance is less than an effective radius of the explosive virtual item, that the explosive virtual item acts on the target virtual character; and

the display module 802 being configured to display the voiceprint indication information corresponding to the target virtual character.

In an aspect, the display module 802 is configured to cancel the display of the voiceprint indication information when a display duration of the voiceprint indication information reaches a first duration, where

the first duration has a negative correlation with the straight-line distance, and the straight-line distance is the distance between the target virtual character and the effective position of the explosive virtual item.

In an aspect, the display module 802 is configured to display a take hit animation of the target virtual character when the explosive virtual item acts on the target virtual character, where the take hit animation is configured for indicating that the target virtual character is under the action of the explosive virtual item, and the take hit animation includes the take hit sound.

The apparatus for displaying an item effect provided in the foregoing aspects is illustrated with an example of division of the foregoing functional modules. In actual application, the functions may be allocated to and completed by different functional modules according to requirements. In other words, the internal structure of the device is divided into different functional modules, to implement all or some of the functions described above. In addition, the apparatus for displaying an item effect and method for displaying an item effect provided in the foregoing aspects belong to the same conception. In an example implementation, reference can be made to the method aspects, and details are not described herein again.

An aspect of this disclosure further provides a computer device, the computer device including a processor and a memory, the memory having at least one program stored therein, and the at least one program being loaded and executed by the processor to implement the method for displaying an item effect provided in the foregoing method aspects.

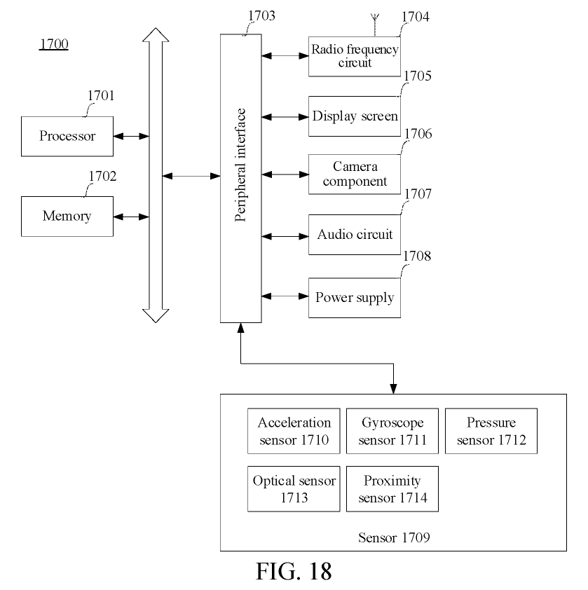

For example, the computer device is a terminal. FIG. 18 is a schematic structural diagram of a terminal according to an aspect of this disclosure. The terminal 1700 includes processing circuitry (for example, a processor 1701) and a memory 1702.

Processing circuitry, such as the processor 1701 may include one or more processing cores, for example, a 4-core processor or an 8-core processor. The processor 1701 may be implemented in at least one hardware form of a digital signal processor (DSP), a field programmable gate array (FPGA), and a programmable logic array (PLA). The processor 1701 may alternatively include a main processor and a coprocessor. The main processor is configured to process data in an awake state, also referred to as a central processing unit (CPU). The coprocessor is a low-power processor configured to process data in a standby state. In some aspects, the processor 1701 may be integrated with a graphics processing unit (GPU). The GPU is configured to render and draw content that needs to be displayed on a display screen. In some aspects, the processor 1701 may further include an artificial intelligence (AI) processor. The AI processor is configured to process a computing operation related to machine learning.

The memory 1702 may include one or more computer-readable storage media, such as a non-transitory computer-readable storage medium. The computer-readable storage medium may be non-transient. The memory 1702 may further include a high-speed random access memory (RAM), and a non-volatile memory such as one or more magnetic disk storage devices and a flash storage device. In some aspects, the non-transient computer-readable storage medium in the memory 1702 is configured to store at least one instruction. The at least one instruction is executed by the processor 1701 to perform the method for displaying an item effect provided in the method aspects of this disclosure.

In some aspects, the terminal 1700 may alternatively include: a peripheral interface 1703 and at least one peripheral. The processor 1701, the memory 1702, and the peripheral interface 1703 may be connected through a bus or a signal cable. Each peripheral may be connected to the peripheral interface 1703 through a bus, a signal cable, or a circuit board. For example, the peripheral includes: at least one of a radio frequency circuit 1704, a display screen 1705, a camera component 1706, an audio circuit 1707, and a power supply 1708.

The peripheral interface 1703 may be configured to connect the at least one peripheral related to Input/Output (I/O) to the processor 1701 and the memory 1702. In some aspects, the processor 1701, the memory 1702 and the peripheral interface 1703 are integrated on a same chip or circuit board. In some other aspects, any one or two of the processor 1701, the memory 1702, and the peripheral interface 1703 may be implemented on a single chip or circuit board. This is not limited in the aspects of this disclosure.

The radio frequency circuit 1704 is configured to receive and transmit a radio frequency (RF) signal, which is also referred to as an electromagnetic signal. The radio frequency circuit 1704 communicates with a communication network and another communication device by using the electromagnetic signal. The radio frequency circuit 1704 converts an electrical signal into an electromagnetic signal for transmission, or converts a received electromagnetic signal into an electrical signal. In some aspects, the radio frequency circuit 1704 includes: an antenna system, an RF transceiver, one or more amplifiers, a tuner, an oscillator, a DSP, a codec chip set, a subscriber identity module card, and the like. The radio frequency circuit 1704 may communicate with another terminal by using at least one wireless communication protocol. The wireless communication protocol includes, but is not limited to, a world wide web, a metropolitan area network, an intranet, generations of mobile communication networks (2G, 3G, 4G, and 5G), a wireless local area network and/or a Wi-Fi network. In some aspects, the radio frequency circuit 1704 may further include a circuit related to near field communication (NFC), which is not limited in this disclosure.

The display screen 1705 is configured to display a user interface (UI). The UI may include a graph, text, an icon, a video, and any combination thereof. When the display screen 1705 is a touch display screen, the display screen 1705 further has a capability of acquiring a touch signal on or above a surface of the display screen 1705. The touch signal may be inputted, as a control signal, to the processor 1701 for processing. In this case, the display screen 1705 may be further configured to provide a virtual button and/or a virtual keyboard that are/is also referred to as a soft button and/or a soft keyboard. In some aspects, there may be one display screen 1705, disposed on a front panel of the terminal 1700. In some other aspects, there may be at least two display screens 1705, respectively disposed on different surfaces of the terminal 1700 or designed in a foldable shape. In still some other aspects, the display screen 1705 may be a flexible display screen, disposed on a curved surface or a folded surface of the terminal 1700. Even, the display screen 1705 may be further set in a non-rectangular irregular pattern, namely, a special-shaped screen. The display screen 1705 may be prepared by using a material like a liquid crystal display (LCD) or an organic light emitting diode (OLED).

The camera component 1706 is configured to acquire an image or a video. In some aspects, the camera component 1706 includes a front-facing camera and a rear-facing camera. The front-facing camera is disposed on the front panel of the terminal 1700, and the rear-facing camera is disposed on a back surface of the terminal. In some aspects, there are at least two rear cameras, which are respectively any of a main camera, a depth-of-field camera, a wide-angle camera, and a telephoto camera, to achieve background blur through fusion of the main camera and the depth-of-field camera, panoramic photographing and virtual reality (VR) photographing through fusion of the main camera and the wide-angle camera, or other fusion photographing functions. In some aspects, the camera component 1706 may further include a flash. The flash may be a monochrome temperature flash, or may be a double color temperature flash. The double color temperature flash refers to a combination of a warm light flash and a cold light flash, and may be configured for light compensation under different color temperatures.

The audio circuit 1707 may include a microphone and a speaker. The microphone is configured to acquire sound waves of a user and an environment, and convert the sound waves into an electrical signal to input to the processor 1701 for processing, or input to the radio frequency circuit 1704 for implementing voice communication. For the purpose of stereo acquisition or noise reduction, there may be a plurality of microphones, respectively disposed at different portions of the terminal 1700. The microphone may further be an array microphone or an omni-directional acquisition type microphone. The speaker is configured to convert electric signals from the processor 1701 or the radio frequency circuit 1704 into sound waves. The speaker may be a thin film speaker, or may be a piezoelectric ceramic speaker. When the speaker is the piezoelectric ceramic speaker, the speaker not only can convert an electric signal into sound waves audible to a human being, but also can convert an electric signal into sound waves inaudible to a human being, for ranging and other purposes. In some aspects, the audio circuit 1707 may further include an earphone jack.

The power supply 1708 is configured to supply power to components in the terminal 1700. The power supply 1708 may be an alternating current, a direct current, a primary battery, or a rechargeable battery. When the power supply 1708 includes a rechargeable battery, and the rechargeable battery may be a wired rechargeable battery or a wireless rechargeable battery. The wired rechargeable battery is a battery charged through a wired circuit, and the wireless rechargeable battery is a battery charged through a wireless coil. The rechargeable battery may be further configured to support a fast charging technology.

In some aspects, the terminal 1700 further includes one or more sensors 1709. The one or more sensors 1709 include, but are not limited to an acceleration sensor 1710, a gyroscope sensor 1711, a pressure sensor 1712, an optical sensor 1713, and a proximity sensor 1714.

The acceleration sensor 1710 may detect a magnitude of acceleration on three coordinate axes of a coordinate system established with the terminal 1700. For example, the acceleration sensor 1710 may be configured to detect components of gravity acceleration on the three coordinate axes. The processor 1701 may control, based on a gravity acceleration signal acquired by the acceleration sensor 1710, the touch display screen 1705 to display the user interface in a landscape view or a portrait view. The acceleration sensor 1710 may be further configured to acquire motion data of a game or a user.

The gyroscope sensor 1711 may detect a body direction and a rotation angle of the terminal 1700. The gyroscope sensor 1711 may cooperate with the acceleration sensor 1710 to acquire a 3D action by the user on the terminal 1700. The processor 1701 may implement the following functions based on the data acquired by the gyroscope sensor 1711: motion sensing (for example, changing the UI based on a tilt operation of the user), image stabilization at shooting, game control, and inertial navigation.

The pressure sensor 1712 may be disposed at a side frame of the terminal 1700 and/or a lower layer of the touch display screen 1705. When the pressure sensor 1712 is disposed at the side frame of the terminal 1700, a holding signal of the user on the terminal 1700 may be detected. The processor 1701 performs left/right hand recognition or a quick operation based on the holding signal acquired by the pressure sensor 1712. When the pressure sensor 1712 is disposed on the low layer of the touch display screen 1705, the processor 1701 controls, based on a pressure operation of the user on the touch display screen 1705, an operable control on the UI. The operable control includes at least one of a button control, a scroll-bar control, an icon control, and a menu control.

The optical sensor 1713 is configured to acquire ambient light intensity. In an aspect, the processor 1701 may control the display brightness of the touch display screen 1705 based on the ambient light intensity acquired by the optical sensor 1713. For example, when the ambient light intensity is high, the display brightness of the touch display screen 1705 is increased. When the ambient light intensity is low, the display brightness of the touch display screen 1705 is decreased. In another aspect, the processor 1701 may further dynamically adjust a camera parameter of the camera component 1706 based on the ambient light intensity acquired by the optical sensor 1713.

The proximity sensor 1714, also referred to as a distance sensor, is disposed on the front panel of the terminal 1700. The proximity sensor 1714 is configured to acquire a distance between the user and the front surface of the terminal 1700. In an aspect, when the proximity sensor 1714 detects that the distance between the user and the front surface of the terminal 1700 gradually becomes smaller, the touch display screen 1705 is controlled by the processor 1701 to switch from a screen-on state to a screen-off state. When the proximity sensor 1714 detects that the distance between the user and the front surface of the terminal 1700 gradually becomes larger, the touch display screen 1705 is controlled by the processor 1701 to switch from the screen-off state to the screen-on state.

A person skilled in the art may understand that the structure of shown in FIG. 18 constitutes no limitation on the terminal 1700, and the terminal 1700 may include more or fewer components than those shown in the figure, or some components may be combined, or in different component arrangements.

An aspect of this disclosure further provides a computer-readable storage medium, the computer-readable storage medium having at least one program stored therein, and the at least one program, when loaded and executed by a processor of a computer device, implementing the method for displaying an item effect provided in the foregoing method aspects.

This disclosure further provides a computer program product or a computer program. The computer program product or the computer program includes computer instructions, and the computer instructions are stored in a computer-readable storage medium. A processor of a computer device reads the computer instructions from the computer-readable storage medium, and the processor executes the computer instructions, to cause the computer device to perform the method for displaying an item effect provided in the foregoing method aspects.

It is noted that all or some of the operations of the foregoing aspects may be implemented by hardware, or may be implemented by a program instructing relevant hardware. The program may be stored in a computer-readable storage medium. The readable storage medium may be a ROM, a magnetic disk, an optical disc, or the like.

What is claimed is:

1. A method for displaying an item effect in a virtual environment, the method comprising:
outputting for display a user interface and a virtual scene of the virtual environment observed from a perspective of a controlled virtual character, the controlled virtual character carrying an explosive virtual item;
receiving, by processing circuitry, an item use operation performed on an item control element in the user interface corresponding to the explosive virtual item;
outputting for display, based on the item use operation, the controlled virtual character using the explosive virtual item, the explosive virtual item being a virtual item that generates an effect within an effective range;
determining, by processing circuitry, whether the explosive virtual item acts on a target virtual character; and
outputting for display, when the explosive virtual item acts on the target virtual character, voiceprint indication information that indicates a source position of a take-hit sound caused by the explosive virtual item acting on the target virtual character.

2. The method according to claim 1, wherein
the voiceprint indication information includes a voiceprint icon displayed on a directional indicator in the user interface, the voiceprint icon indicating at least one of:
a direction of the target virtual character relative to the controlled virtual character, or
a distance between the target virtual character and the controlled virtual character; and
a display position of the voiceprint icon on the directional indicator indicates the direction of the target virtual character relative to the controlled virtual character; and
a display size of the voiceprint icon on the directional indicator indicates the distance between the target virtual character and the controlled virtual character.

3. The method according to claim 2, wherein the voiceprint icon displayed on the directional indicator changes based on at least one of:
a position of the controlled virtual character,
a position of the target virtual character, or
an orientation of the controlled virtual character.

4. The method according to claim 1, wherein the explosive virtual item is a direct-hit virtual item that acts on the target virtual character when the target virtual character is located within the effective range and no obstacle exists between an effect position of the explosive virtual item and the target virtual character.

5. The method according to claim 4, further comprising:
calculating a distance between the effect position of the explosive virtual item and the target virtual character; and
when the distance is less than an effective radius of the explosive virtual item, casting at least one detection line from the effect position to at least one key joint point of the target virtual character, and
determining, when no obstacle is detected along the at least one detection line, that the explosive virtual item acts on the target virtual character, wherein
the at least one key joint point includes at least one of a head joint point, a chest joint point, a hip joint point, a leg joint point, or a foot joint point.

6. The method according to claim 1, wherein
the explosive virtual item is an indirect-hit virtual item that passes through an obstacle between an effect position of the explosive virtual item and the target virtual character, and acts on the target virtual character within the effective range.

7. The method according to claim 6, further comprising:
calculating a distance between the effect position of the explosive virtual item and the target virtual character; and
determining, when the distance is less than an effective radius of the explosive virtual item, that the explosive virtual item acts on the target virtual character.

8. The method according to claim 1, further comprising:
canceling the display of the voiceprint indication information when a display duration of the voiceprint indication information reaches a threshold duration, wherein
the threshold duration has a negative correlation with a distance between the target virtual character and an effect position of the explosive virtual item.

9. The method according to claim 1, further comprising:
outputting for display a take-hit animation of the target virtual character when the explosive virtual item acts on the target virtual character, the take-hit animation indicating that the explosive virtual item acts on the target virtual character, and the take-hit animation including the take-hit sound.

10. An apparatus for displaying an item effect in a virtual environment, the apparatus comprising:
processing circuitry configured to:
output for display a user interface and a virtual scene of the virtual environment observed from a perspective of a controlled virtual character, the controlled virtual character carrying an explosive virtual item;
receive an item use operation performed on an item control element in the user interface corresponding to the explosive virtual item;
output for display, based on the item use operation, the controlled virtual character using the explosive virtual item, the explosive virtual item being a virtual item that generates an effect within an effective range;
determine whether the explosive virtual item acts on a target virtual character; and
output for display, when the explosive virtual item acts on the target virtual character, voiceprint indication information that indicates a source position of a take-hit sound caused by the explosive virtual item acting on the target virtual character.

11. The apparatus according to claim 10, wherein
the voiceprint indication information includes a voiceprint icon displayed on a directional indicator in the user interface, the voiceprint icon indicating at least one of:
a direction of the target virtual character relative to the controlled virtual character, or
a distance between the target virtual character and the controlled virtual character; and
a display position of the voiceprint icon on the directional indicator indicates the direction of the target virtual character relative to the controlled virtual character; and
a display size of the voiceprint icon on the directional indicator indicates the distance between the target virtual character and the controlled virtual character.

12. The apparatus according to claim 11, wherein the voiceprint icon displayed on the directional indicator changes based on at least one of:
a position of the controlled virtual character,
a position of the target virtual character, or
an orientation of the controlled virtual character.

13. The apparatus according to claim 10, wherein the explosive virtual item is a direct-hit virtual item that acts on the target virtual character when the target virtual character is located within the effective range and no obstacle exists between an effect position of the explosive virtual item and the target virtual character.

14. The apparatus according to claim 13, wherein the processing circuitry is configured to:
calculate a distance between the effect position of the explosive virtual item and the target virtual character; and
when the distance is less than an effective radius of the explosive virtual item,
cast at least one detection line from the effect position to at least one key joint point of the target virtual character, and
determine, when no obstacle is detected along the at least one detection line, that the explosive virtual item acts on the target virtual character, wherein
the at least one key joint point includes at least one of a head joint point, a chest joint point, a hip joint point, a leg joint point, or a foot joint point.

15. The apparatus according to claim 10, wherein
the explosive virtual item is an indirect-hit virtual item that passes through an obstacle between an effect position of the explosive virtual item and the target virtual character, and acts on the target virtual character within the effective range.

16. The apparatus according to claim 15, wherein the processing circuitry is configured to:
calculate a distance between the effect position of the explosive virtual item and the target virtual character; and
determine, when the distance is less than an effective radius of the explosive virtual item, that the explosive virtual item acts on the target virtual character.

17. The apparatus according to claim 10, wherein the processing circuitry is configured to:
cancel the display of the voiceprint indication information when a display duration of the voiceprint indication information reaches a threshold duration, wherein
the threshold duration has a negative correlation with a distance between the target virtual character and an effect position of the explosive virtual item.

18. The apparatus according to claim 10, wherein the processing circuitry is configured to:
output for display a take-hit animation of the target virtual character when the explosive virtual item acts on the target virtual character, the take-hit animation indicating that the explosive virtual item acts on the target virtual character, and the take-hit animation including the take-hit sound.

19. A non-transitory computer-readable storage medium storing instructions which, when executed by a processor, cause the processor to perform:
outputting for display a user interface and a virtual scene of a virtual environment observed from a perspective of a controlled virtual character, the controlled virtual character carrying an explosive virtual item;
receiving an item use operation performed on an item control element in the user interface corresponding to the explosive virtual item;
outputting for display, based on the item use operation, the controlled virtual character using the explosive virtual item, the explosive virtual item being a virtual item that generates an effect within an effective range;
determining whether the explosive virtual item acts on a target virtual character; and
outputting for display, when the explosive virtual item acts on the target virtual character, voiceprint indication information that indicates a source position of a take-hit sound caused by the explosive virtual item acting on the target virtual character.

20. The non-transitory computer-readable storage medium according to claim 19, wherein
the voiceprint indication information includes a voiceprint icon displayed on a directional indicator in the user interface, the voiceprint icon indicating at least one of:
a direction of the target virtual character relative to the controlled virtual character, or
a distance between the target virtual character and the controlled virtual character; and
a display position of the voiceprint icon on the directional indicator indicates the direction of the target virtual character relative to the controlled virtual character; and
a display size of the voiceprint icon on the directional indicator indicates the distance between the target virtual character and the controlled virtual character.
